(19) United States
(12) Patent Application Publication
(10) Pub. No.: US 2004/0054701 A1
(43) Pub. Date: Mar. 18, 2004

(54) Modeless gesture driven editor for handwritten mathematical expressions

(76) Inventor: Peter F. Garst, Palo Alto, CA (US)

Correspondence Address: GOODWIN PROCTER L.L.P, 103 EISENHOWER PARKWAY, ROSELAND, NJ, 07068, US

(21) Appl. No.: 10/378,386

(22) Filed: Mar. 3, 2003

Related U.S. Application Data
(60) Provisional application No. 60/360,949, filed on Mar. 1, 2002.

(51) Int. Cl. G06F 1/00

(52) U.S. Cl. 708/131

(57) ABSTRACT

Provided herein is a pen-based editing system for manipulating mathematical expressions. Through a largely gesture based, directly manipulative interface, the system allows a user to make conventional changes to expressions, such as copy and move, and also to work with the expressions in ways peculiar to the problem domain, including, for example, handling ambiguity, expression fragments and alternate recognitions. The system is a generalization of an online recognizer for mathematical expressions. The system uses the same basic recognition techniques as the online recognizer, however the input information available to the editor is more varied, including mixtures of known and unknown characters and positional relations.

### STATEMENT REGARDING FEDERALLY SPONSORED RESEARCH OR DEVELOPMENT

The funding for work described herein was provided by the Federal Government, under a grant from the National Science Foundation. The Government may have certain rights in the invention.

### BACKGROUND

1. Field of the Invention

The present invention relates generally to data processing and more particularly, to modeless gesture driven editing of handwritten mathematical expressions.

2. Description of Related Art

Prior art systems for online and offline editing of mathematical expressions include the following.

There are several approaches to editing mathematical text which do not involve direct manipulation. T_{E}X and its many extensions such as La T_{E}X, etc, is a typesetting system that produces typeset documents of the highest quality. It is particularly strong on complicated mathematics. T_{E}X relies on control sequences embedded in the text to encode mathematical notation. Any text editor will do to modify the expressions. MathML, a product of the W3C Math Working Group, is a specification for describing mathematics as a basis for machine to machine communication. MathML, like T_{E}X, is a text based system in which expressions can be manipulated with a text editor. The text formatting product Framemaker, and other similar packages, uses a graphical user interface (GUI) based system having a template-based facility for entry and editing of mathematics. The user typically selects overall expression forms, such as fractions, definite integrals, and so on. The user can then fill in slots in the templates with other templates, by selecting special symbols such as Greek letters from a list of options, or by typing in data.

Prior art pen based editors of mathematical expressions include the following: Smithies et al, “A Handwriting-Based Equation Editor,” Graphics Interface '99, Kingston, Ontario, pp. 84-91, describes a system whereby the user enters a handwritten expression. As the user writes, the system annotates the ink with character labels. The user can enter select and move mode to modify the input ink if required. If the system has made any segmentation mistakes—splitting what should be one character into parts or joining what should be separate characters together, the user enters modify characters mode to fix them. At this point the user submits the input to the parser. If there are any errors, the user can move pieces of the expression and reparse the input. The typeset expression resulting from the parse is shown in a separate window.

H. Okamura et al “Handwriting interface for computer algebra systems,” Proceedings of the Fourth Asian Technology Conference in Mathematics, Guangzhou, 1999, pp. 291-300, describes a system that also breaks down the entry process into smaller steps, but by working a character at a time. As the user draws each character it is recognized and put in position. If there are any errors, the user corrects them at the time the character is drawn.

Some math recognizers have separate handwriting and text displays. The user enters an expression, and when the system recognizes it the text appears in a second window. The user may be able to modify the handwriting in order to edit the expression. However, this has a number of disadvantages. Having two expressions which are supposed to represent the same thing is a greater cognitive burden for the user. As the expression changes through various editing operations there is no reasonable way to keep the two versions in sync—think of moving a piece of an external textual expression in.

Other systems use a number of input modes. The first version of this system used two, for input and editing; some systems have more, with different modes for different types of manipulation and correction. The intuitive case for modes seems strong—the variety and complexity of the input required seems to make modes desirable both for simplifying the complexity of the task for the user and in finding distinct ways to express the many possible inputs. However, usability studies with naive subjects showed persistent confusion between the modes, despite attempts to provide prominent visual cues.

Therefore, despite the various approaches of existing prior art editing systems, there remains a need for a more efficient and intuitive pen-based interface for editing mathematical expressions.

### SUMMARY OF THE INVENTION

Provided herein is a modeless pen based editor for mathematical expressions useful for correcting recognition results from handwritten or scanned input and for exploratory manipulation of expressions. The editor provides a list of editing actions and an interface which makes the editing actions accessible to the user. The interface of the present embodiment centers on a main window which acts as input area, display, and clipboard. The editing commands are most conveniently invoked through gestures and direct manipulation of the expressions, although they can also be invoked by more traditional means, such as buttons or menu choices. Similarly, undo/redo or other system actions unrelated to editing mathematics may also be driven by gestures and share the same gesture recognizer.

Of particular import, is the modeless feature of the editor thereby providing enhanced usability for users. The editor herein distinguishes data strokes from gesture strokes, matches strokes to expressions, erases and redraws strokes to correct input and performs additional editing functions all in a modeless manner.

The editor generalizes a recognizer for mathematical expressions. The function of a recognizer for mathematical expressions is to take unknown input, such as handwritten strokes or scanned expressions, and interpret it as a meaningful mathematical expression, not just a jumble of symbols. Similarly, the typical editing action proceeds by first creating input reflecting the information available. Some of the input may be known characters; for example, if the editing action involves moving a subexpression, the characters in the subexpression are still the same and can be used as part of the editor's input. Some of the input may be handwritten or scanned characters. Some of the positional relationships among the elements of the expression will be known explicitly, such as positional relationships among the characters in a subexpression which the user moves as a unit. Some positional relationships may need to be estimated from location information. Once the input reflects all the known information about the editor's target expression, the editor finds the best available interpretation of the information as a valid expression.

The editor also handles ambiguous expressions and processes ungrammatical expressions.

In one embodiment, the editor is tightly integrated with an online recognizer for handwritten mathematical expressions, as part of a complete system for efficient handwritten input of mathematics. In an alternate embodiment, the editor is used in conjunction with an offline recognizer working with scanned images. In a further embodiment, the editor is used purely as part of a text formatting system without any recognizer. In still another embodiment, the editor is used as part of a data visualization tool.

### ADVANTAGES OF THE PRESENT INVENTION

The present invention represents a significant advance over the prior art. This section considers prior art in four areas, and shows how the prior art relates to the present invention in each of these areas. The areas are: gesture based editors for text, pen-based editors for mathematical notation, keyboard and mouse based systems for manipulating mathematical notation and pen-based calculators.

Modeless gesture based editors for plain text have been common in the industry for some time. These systems typically allow a user to select, delete, insert, copy and move text in a document, and thus they bear on the present invention, which as a subset of its functionality allows users to select, delete, insert, copy and move subsets of mathematical expressions. The present invention surpasses this prior art because of the far more complex nature of the application domain. In editing text, the user edits a linear sequence of words and letters. In editing mathematical expressions, the user edits a complex two dimensional structure. Doing so requires the use of the state of the art parsing technology described below. Consider, for example, a deletion, one of the simplest possible edits. In editing text, the editor simply drops a range of words or letters and closes up the gap. In editing mathematics, the editor must first consider how the remaining characters are positionally related to each other after the deletion of some characters disrupts the web of positional relations. There may not be an unambiguous answer—the editor may need to evaluate several possibilities. Then the editor must submit the remaining characters and their deduced positional relations to a parser in order to discover whether or not this configuration can be interpreted as a valid mathematical expression. If it cannot be, the editor may see if the insertion of one or more wildcard characters allows the input to be interpreted as a valid mathematical expression. In short, while the use of a modeless deletion gesture seems very similar to the user in these two domains, the actual overlap in the methods of the two editors is small.

Now consider prior pen-based editors for mathematical notation. We take Smithies' system “A Handwriting-Based Equation Editor,” Graphics Interface '99, Kingston, Ontario, pp. 84-91 as representative of the state of the art. This system is aimed at correcting the recognition of a handwritten expression rather than providing general methods for manipulating mathematics. For example, to change a subscript to an exponent one must go back to the original ink and change its position. There is no concept of moving pieces from one expression to another. Within the limited range of manipulations allowed, the user must enter the appropriate mode and then is limited to a very specific type of change, depending on the mode. While there is some overlap in functionality, the nature of the interface and the methods used to support it are very different.

There are systems for manipulating mathematical expressions in specific ways with keyboard and mouse. Besides the template based entry systems discussed earlier, consider U.S. Pat. No. 5,189,633, which is the Theorist system for computer mathematics. The Theorist system allows some manipulations similar to those of the present invention. The user enters an expression with the keyboard, but can then select a subexpression with the mouse and drag it to a new location. The aim of the Theorist system is not to provide a general facility for manipulating expressions, but to maintain the truth value of an equation under specific types of manipulation. That is, if the user moves a subexpression, the rest of the equation changes in order to keep the resulting equation consistent with the original one. Thus the Theorist system is different in many ways from the present invention, including at least the following: It does not use a modeless interface, since the user enters data with the keyboard and editing commands with the mouse. It provides a small subset of the manipulation methods of the present invention. The expression manipulation it provides modifies expressions in specific ways aimed at solving them, rather than the general transformation consistent with the syntax provided by the present invention. Finally, the methods it uses are completely different, since it allows specific changes which the system knows how to manipulate, while the present invention takes a full recognition approach to a more general set of changes.

Pen based calculators, exemplified by the Smartpad calculator described in U.S. Pat. Nos. 5,428,805 and 5,655,136 also share some characteristics with the present system. This calculator uses a scratch paper metaphor to support calculations on numbers. It provides two types of manipulation relevant to the present invention. On the lower level, the user can edit numbers using what is, in effect, a modeless gesture driven text editor. There are gestures for selection, deletion, and so on; but since the edited objects are just numbers, this facility is essentially the same as the editing of text described above. The user can also manipulate the various objects on the display, for example by selecting one or more and moving the selection to a new location on the display. In general this facility is like other drag and drop interfaces and has nothing to do with editing mathematics. The one exception is that the user can move a number or operator into a horizontal or vertical calculation. This has something of the spirit of the present invention, but of course is very different from the recognition based facility for performing complex manipulations of general mathematical expressions provided by the present invention.

The above-mentioned aspect(s) and other aspects, features and advantages of the present invention will become better understood with regard to the following description, appended claims, and accompanying drawings.

### BRIEF DESCRIPTION OF THE DRAWING(S)

Referring briefly to the drawings, embodiments of the present invention will be described with reference to the accompanying drawings in which:

FIG. 1 illustrates a first aspect of the present invention in accordance with the teachings herein.

FIG. 2 illustrates a second aspect of the present invention in accordance with the teachings herein.

FIG. 3 illustrates a third aspect of the present invention in accordance with the teachings herein.

FIG. 4 illustrates a fourth aspect of the present invention in accordance with the teachings herein.

FIG. 5 illustrates a fifth aspect of the present invention in accordance with the teachings herein.

FIG. 6 illustrates a sixth aspect of the present invention in accordance with the teachings herein.

FIG. 7 illustrates a seventh aspect of the present invention in accordance with the teachings herein.

FIG. 8 illustrates an eighth aspect of the present invention in accordance with the teachings herein.

FIG. 9 illustrates a ninth aspect of the present invention in accordance with the teachings herein.

FIG. 10 illustrates a tenth aspect of the present invention in accordance with the teachings herein.

FIG. 11 illustrates an embodiment of the present invention constructed in accordance with the teachings herein.

FIG. 12 is a block diagram illustrating an aspect of the modeless functionality of the present invention.

FIG. 13 is a block diagram illustrating an aspect of a recognizer adapted for use with the present invention.

FIG. 14 is a block diagram illustrating an exemplary embodiment of a processor-controlled system on which the present invention is implemented.

FIGS. 15-40 depict exemplary user interfaces embodying the present invention.

### DETAILED DESCRIPTION OF THE PRESENT INVENTION

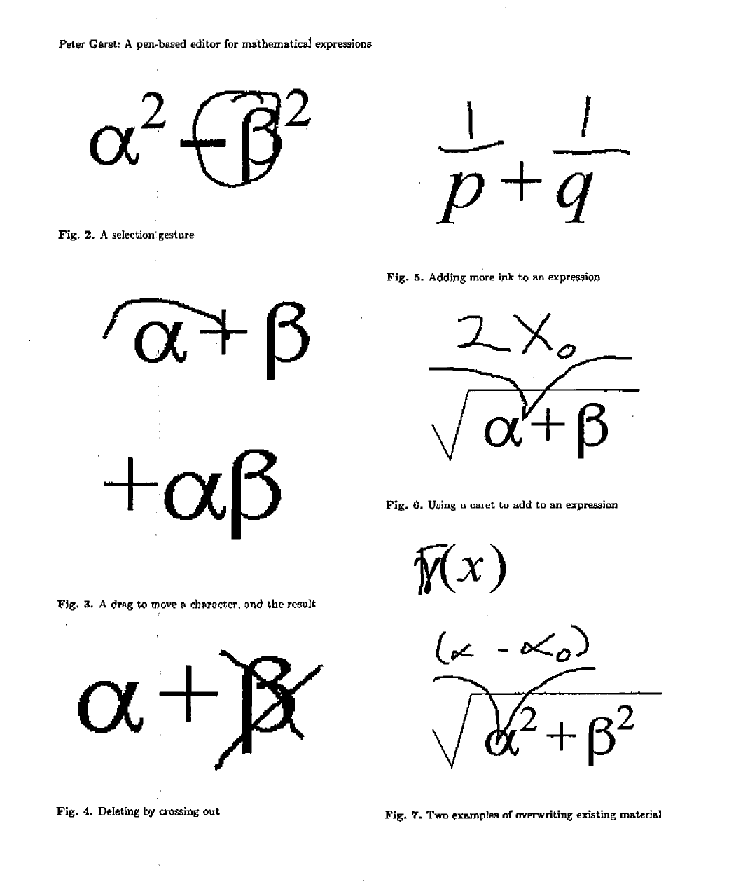

Referring more specifically to the drawings, for illustrative purposes the present invention is embodied in the system configuration, method of operation and application code, generally shown in FIGS. 1-[insert]. Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

It will be appreciated that the system, method of operation and product described herein may vary as to the details without departing from the basic concepts disclosed herein. Moreover, numerous specific details are set forth in order to provide a more thorough description of the present invention. However, all specific details may be replaced with generic ones. Furthermore, well-known features have not been described in detail so as not to obfuscate the principles expressed herein.

### Overview

FIG. 11 illustrates aspects of a gesture-driven modeless editing system 1100 constructed in accordance with the teachings herein. As shown, the editing system or editor 1100 includes a plurality of interconnected components: a recognition component 1105 and an interface component 1110 for providing, among other things, user workspace 1115. The fundamental purpose of the editor is to manipulate parse trees for a grammar covering some set of mathematical expressions. The editor is not strongly dependent on the exact nature of the grammar, and reasonable modifications to the grammar would not affect anything in the following description. The currently implemented grammar includes the usual mathematical notation through multivariate calculus, matrices, and set notation.

The parse trees are represented on the screen by textual expressions. At many points during the editing process the screen shows a mixture of text and ink, the ink representing user input; it is only the text that is the object of manipulation. In the present embodiment there can be multiple independent expressions on the display at the same time, but alternate embodiments may support editing of only a single expression at a time.

### Editing Capabilities

The following section sets forth a non-exhaustive list of editing capabilities provided by the present system.

### Main Editing Capabilities

1. The user can select part or all of an expression. This does not change the parse tree, but rather sets up a portion of it as a source or target for a later action. It is tempting to require selection of entire sub expressions of the object, but this is too restrictive. The selected pieces do not need to be grammatical sub expressions; but they do need to be contiguous pieces of an expression. For example, given the expression “α+β” the user can select “α+”, which is not a valid expression in the current grammar; but not “α β”—that is, not several expression pieces without any direct positional relation. As another example, given the expression

$$\frac{a + b}{c + d}$$

the “a” and “c” are physically contiguous but they are not a valid selection. However, “a+b” is a valid selection.

2. The user can move a character or selected piece from one place to another in the same expression or a different one. The target location can be empty—such as a new exponent on a character, or after the existing expression—or it can be on top of something that already exists, in which case the target is replaced. The target can be a character or a selected part of an expression.

3. The user can copy a character or selected piece from one place to another in the same expression or a different one. This is just like a move, except the source is not deleted.

4. The user can delete part or all of an expression. The deleted part is subject to the same contiguity constraints as selection. The user may delete disconnected pieces in several operations.

5. The user can add more handwritten material to an existing expression. Even if the expression originated in a scanned document or was imported from another application, the user can write more characters which are recognized and incorporated into the expression. To perform this task, the editor includes a complete recognizer of handwritten mathematics as a subset. It also possible to build a simpler editor, not including a full recognizer, by forgoing this functionality.

6. The user can overwrite parts of an existing expression with new material. This is like adding more material, except that the overwritten material is removed and replaced with the new.

7. The user can request alternate recognitions of parts of expressions. A recognizer of mathematical expressions will be far more accurate if one considers a set of guesses rather than just the best guess, and it is important to give the users access to this information.

8. The user can get information to disambiguate an expression. This capability will be discussed in more detail later.

9. The user can undo and redo editing actions. This capability involves proper storage and retrieval of system states rather than manipulations of the expressions.

### Editing Interface

The following section sets forth how the editing interface makes the editing interface tools and facilities available to the user in the preferred embodiment.

The modeless nature of the interface is a key design principle. “Modeless” is a description of how the user interacts with the system. It means that the user can take any appropriate action, either entering new data (if the embodiment supports a full handwriting recognizer) or taking any editing action, without first setting a mode to tell the system what he or she is about to do. This is in contrast to existing systems, which may have explicit modes for input and for editing, or may have implicit modes by using the keyboard for data input and the mouse for editing input, for example. The greater simplicity and naturalness of modeless interfaces leads to a significant improvement in utility and efficiency.

Because the user does not tell the editor what he or she is about to do, the editor must use better design and better methods in order to properly interpret the user's input. One key element is a design which allows some segmentation of the possible inputs. For example, only textual expressions are edited; ink is not edited. Thus, for example, if the user enters a stroke in the vicinity of a partial handwritten expression, the editor knows that it is not an editing gesture.

The second key element in a modeless interface is recognition methods which allow the editor to distinguish the different possible user inputs without the crutch of a mode which limits the possibilities. This involves careful work on identifying the input strokes in light of the context where they are entered, timing information, for example in distinguishing two stroke gestures from one stroke gestures and a willingness to try several possibilities and see which works best. These points are discussed in more detail below.

In the preferred embodiment each expression is represented only once on the display. The current system enables the user to check the accuracy of the recognition by allowing the user to flip between the handwriting and text using the undo/redo commands.

The preferred embodiment supports multiple independent expressions at once. FIG. 1 shows a typical window state of the editor showing three independent expressions. As shown, the editor has a main window 100 where both input ink and textual equations are displayed. Expressions 105 and 110 are in textual form and are ready for user action. . Expressions 115 is in the middle of an editing operation—the addition of new material to an existing expression. In one embodiment of the present system, during runtime the expressions have light background colors which define their extent and indicate which is current.

In carrying out its operations, the preferred embodiment uses a clipboard metaphor. For example, instead of using a copy/paste menu operation, the user can copy part of an expression to another place on the display, and then use it as a source for other editing operations. As long as it is somewhere in the main window, if is essentially on the clipboard and ready for use. Expressions in different parts of the window are independent of each other, but the user can copy or move material between them. Internally the editor attaches a different instance of the recognizer to each independent expression on the display. An application utilizing the editor may create logical or mathematical relations between expressions in different parts of the display, so at the user level the expressions may not be independent.

### Editing Gestures

Editing tasks (i.e. cut/copy/paste) can be accomplished using the following editing gestures. The association between gestures and editing commands is not limited to the gestures described here. In fact, in the preferred embodiment the user can choose to associate different gestures with these editing commands in some cases.

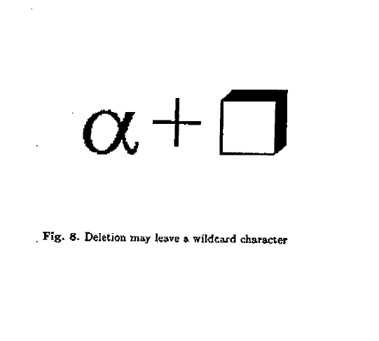

SELECT: The user selects part of an expression with the selection gesture. In the preferred embodiment the selection gestures is a circle around the portion to be selected. In the preferred embodiment each expression can have one piece selected at a time, so circling one part of an expression eliminates any preexisting selection in the same expression. As soon as the selection gesture is recognized, the selected part of the expression is highlighted, for example by using characters of a different color or drawing a border around the selection, and the selection gesture disappears from the interface. FIG. 2 shows an example, after the selection gesture has been entered but before it has been recognized and removed. The selected part does not represent a complete subexpression, but as required it is one contiguous piece.

MOVE: The user moves pieces by dragging them. The user places the pen down in the character or selection to be moved, and drags the pen to the target location. As soon as the pen lifts; the editor recognizes the request: it then erases the dragging stroke and performs the move. There are a number of possibilities for the target. It can be an empty area away from other expressions; in this case the material forms a new, self-contained expression at the target location. The target can be an empty place in an existing expression, or it can be on top of a character or selection in an existing expression. FIG. 3 shows an example during and after a move.

COPY: Copy operates just like move, except the source material is not deleted. Copy can also be performed by dragging the source material, but with a modifier, such as simultaneously pressing the shift key or a button on the pen. In an alternate embodiment the move operation requires a modifier.

DELETE: The user deletes part or all of an expression by drawing a deletion gesture over it. In common embodiments the deletion gesture may be a scratch out motion, or may look like an X which crosses out the material. The deleted material consists of the characters under the gesture, or the whole selection if part of a selection is covered. In the special case of a bracketed expression, the user can delete both brackets by using the deletion gesture on one of them. FIG. 4 illustrates deletion.

INSERT: The user adds more material to an expression by writing the new characters and indicating where they go. The easiest way to do this is to write them in place. FIG. 5 illustrates this point. However, if there is insufficient room to write the material in, the user can use an insertion gesture; in the preferred embodiment this is a caret. The user writes the new material and uses a gesture to indicate its target location. FIG. 6 illustrates this point. As an alternate way to perform the same task, the user can also write the new material for recognition elsewhere on the display and then drag it to the target location.

OVERWRITE: Overwriting material is similar to adding new material. If the user writes new characters on top of old, the old characters are removed and the new characters replace the old. The “old” material consists of the characters immediately under the new ink, or the whole selection if part of it is under the new ink. The user can also use an insertion gesture to indicate the target for new ink: the new material replaces the character or selection under the point of the caret or other insertion gesture. FIG. 7 illustrates this point.

ALTERNATE SUGGESTIONS: If the editor is used in conjunction with a recognizer, the user can get the next alternate recognition for a character or selection, or a list of the possible alternates, with the appropriate gestures. In the preferred embodiment one tap indicates the next alternate and a double tap indicates the full list of alternates. For example, in the handwritten case a “2”′ might be confusable with a “z” or partial derivative symbol. Positionally, multiplication could be confusable with exponentiation. There may also be syntactic ambiguity, and the alternate recognitions might reflect not different choices for characters or positions but different ways of interpreting them.

Note that overwriting introduces an element of ambiguity into the editing gestures due to the modeless nature of the interface. That is, does a circle represent a selection or replacement with a “0”? Also, if the user writes an “x”′ on top of a character or selection, is it to delete or replace the material? The editor addresses this ambiguity by interpreting the input as a gesture when possible. Thus, in the “x” example above, the editor will treat the input as a deletion if it matches the current delete gesture and comes on top of characters or the selection. The user can replace material with an “x”, if that is the deletion gesture, by writing it elsewhere and dragging it onto the target.

### Parsing Edited Information

Described above are editing tools available to the user and the interface that provides them. The following sections describe the methods used by the editor to provide the facilities and support the interface described above.

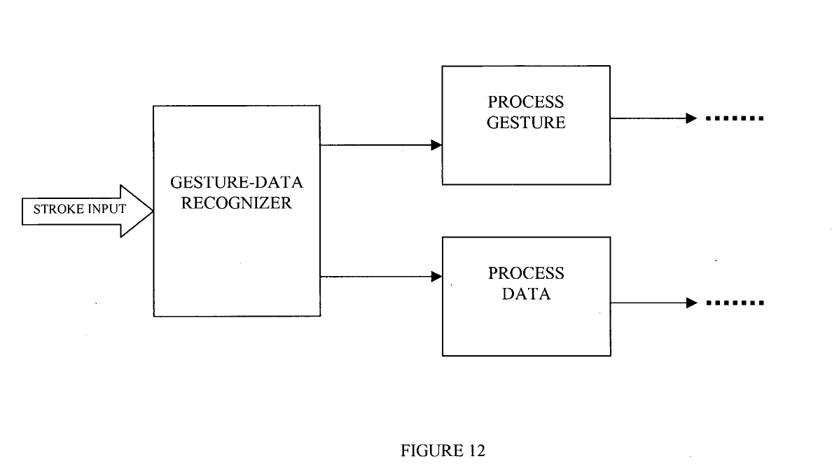

The first task of the system is to recognize the editing gestures to determine what is a selection, what is a drag, what is an insertion caret, etc. FIG. 12 is a block diagram illustrating this aspect of the editor. In one embodiment of the present invention, in which the editor is closely associated with a recognizer of handwritten mathematics, the editor first looks for a valid interpretation of the input as a gesture, and then treats the input as a data stroke for the recognizer if no such interpretation is found. In this embodiment the set of gestures is small, and none have more than two strokes, so the recognition is mostly a set of logical tests, supplemented by an underlying character recognizer for a few gestures; such as insertion carets. The system uses information about the start point location, end point, and the characters or selection underneath the proposed gesture as well as shape information in distinguishing the gesture set. In one embodiment the editor is also configured to try several interpretations of the input stroke, so that if the editor fails or gets a poor score when it tries to carry out the editing action specified by the first interpretation of the input, it can try a second interpretation or treat the input as a data stroke.

The gesture recognition component of the editor identifies the type of the gesture and also information on the operands of the gesture when required. A selection or deletion gesture requires information on the target of the gesture; a drag requires information on the source and target. There are several possible types of operands. Selection and deletion operate on a set of contiguous characters. Most other gestures identify the operand by a single point location, such as the endpoint of a drag operation. The point location can be on a character, on a selection, or in a specified positional relation to a character, such as in exponent or subscript position. In one embodiment the editor uses a statistical position model to identify the most likely operand given a point location in a textual expression. There are cases, such as when the location is on a very narrow character, for which a simple inside/outside decision is a less accurate reflection of the user's intention than a more carefully constructed position model.

We will now assume that the editor has interpreted the input gesture and is ready to do the editing action requested by the gesture. Thus the editor has a textual representation of a mathematical expression, and a gesture type, such as drag or delete, and information on the operands. In the preferred embodiment the editor supports handwritten additions to textual expressions, and we will assume that is the case in this discussion, although a simpler alternate embodiment may forgo this functionality. In the case of added ink, the information available is the textual expression and the new ink strokes.

The editor uses a two step method to implement the editing operations and generate the output expressions. First it generates an input set reflecting the information it has about the desired expression; then it uses a pattern recognition technique to identify the mathematical expression most likely represented by the input data. In the preferred embodiment the editor then displays the resulting expression for the user in place of the unedited expression, although other embodiments may use another location or method to communicate the results to the user. It is instructive to compare this to a recognizer for handwritten mathematics. The recognizer assembles an input set consisting of a list of handwritten strokes; the information thus includes the shape of the strokes and their positions. The recognizer then uses a pattern recognition technique to identify the expression most likely represented by the input. In the editor case the input set may contain handwritten strokes, but it may also contain known characters from the expression being edited. The positional relations in the editor case may in part depend on the placement of strokes on the display, as for the recognizer, but may also depend on known positional relationships of elements of the edited expression, and on positional relations mediated through point locations in the target. Thus we see that the editor generalizes the recognizer, accepting the same types of input that the recognizer does and also additional types of input information.

### Symbolic Positional Information

As discussed, for editing operations the data includes both known characters and ink representing unknown characters. An exactly analogous situation obtains for the positional relations. In most editing operations there are some positional relations that are known, because they are unchanged from the starting textual expression. For example, during a move operation a positional relation inside the moved material, or a positional relation well away from the editing action will not be changed by the edit. There are also usually positional relations which are unknown and must be recognized from geometric information, just as a character is recognized from ink. The relations between moved and unmoved characters, or between text and new ink fall into this category. Positional relations can also be broken by deletions or insertions which get in the way. So, just as for the characters some of the positional relations will be known exactly, and some of them will need to use a quantitative score generated by a statistical model.

There are symbolic positional relations which represent known positional relations, and stand for a set of broadly similar statistical position models. For example, there is a symbolic pairwise positional relation called EXPONENT which covers upper limits of integration and ordinary exponents, which have different quantitative models in the preferred embodiment. A set of six symbolic positional relations is used in the preferred embodiment: they are LEFT-RIGHT, OVER, SUBSCRIPT, EXPONENT, SQRT and NTHROOT. The last is used to describe the relation between the 3 and the radical in an expression like {cube root}\sqrt{n}.

Known positional relations within matrices are handled somewhat differently. People write matrices in almost arbitrary element order, so the pairwise positional approach breaks down. A symbolic positional description of a matrix is just an assignment of each element to its position.

### Classes of Positional Relations

In order to properly recognize the data available in an editing action, the system assigns a position class to each pair of input units, text or ink. Then if during recognition a particular positional relation is alleged between two units, the system determines the position class which obtains between them and generates a score for the relation using the methods from the class. For mixed classes, such as if an alleged exponent is a mixture of text and ink, the system determines several positional classes, and the positional score of the exponent relative to the base may use one or more of them depending on the details.

The present embodiment uses the following positional classes:

INK-TO-INK CLASS: This class is used to score positional relations between characters or subexpressions represented as ink strokes. In the preferred embodiment it contains a set of quantitative statistical models which use the relative positions of the strokes to return a score for a hypothesized positional relation between elements.

INK-TO-TEXT CLASS: This class is used to score positional relations between textual characters and characters represented by handwritten strokes. This class is used, for example, if the user adds more handwriting to an existing expression. The models in this class follow the same form as the ink-to-ink class, but may be separately trained and so have different parameters. Some of the additional processing regarding intersections and such may be handled differently in this class.

SYMBOLIC CLASS: This class is used when text symbols have known positional relations, as discussed above.

LOCATION CLASS: This class is used when the positional relation of text or ink to other textual material is mediated through a single point location. If the user drags material to a location in an expression then there is a set of characters which logically occupies a single point position relative to the surrounding text. This class is also used for ink-to-text relations if ink is mapped to a particular point using an insertion caret.

### The Input Data

The input data for the editor contains character information and position information.

The character information is of several types. It may include specific characters valid as parts of mathematical expressions. For example, in a deletion operation the undeleted characters would be known explicitly. It also may include handwritten strokes representing such characters. At this point the gestures have been identified and removed, so the editor may assume any remaining handwritten strokes represent characters. In the preferred embodiment the editor assumes that each character is represented by a contiguous sequence of strokes, except that the editor looks for t-crosses and dots on i and j which are delayed. The character information may also include wildcard characters, as discussed below. This model, in which the input data for the editor is a mixture of text and ink, does not support modifications to existing characters—converting “−” to “+” by adding a single downstroke, for example.

The position information available in the input set is a more complex mix. As discussed above there are various positional classes which apply to the positional relations between different parts of the input, and the positional information may be available as known symbolic relations or as geometric information which must be scored using a quantitative model. When the editor constructs the input data for its operations it must specify this positional information. Most of the positional relations are resolved later at the recognition stage, but in the preferred embodiment the editor sets up new symbolic positional relations at this stage when required by deletions in the material, either explicit or because a subset is being moved out or replaced. The preferred embodiment includes a set of rules for determining a symbolic positional relation between two characters, both of which have a symbolic positional relation to deleted material.

### Recognizing the Input Data

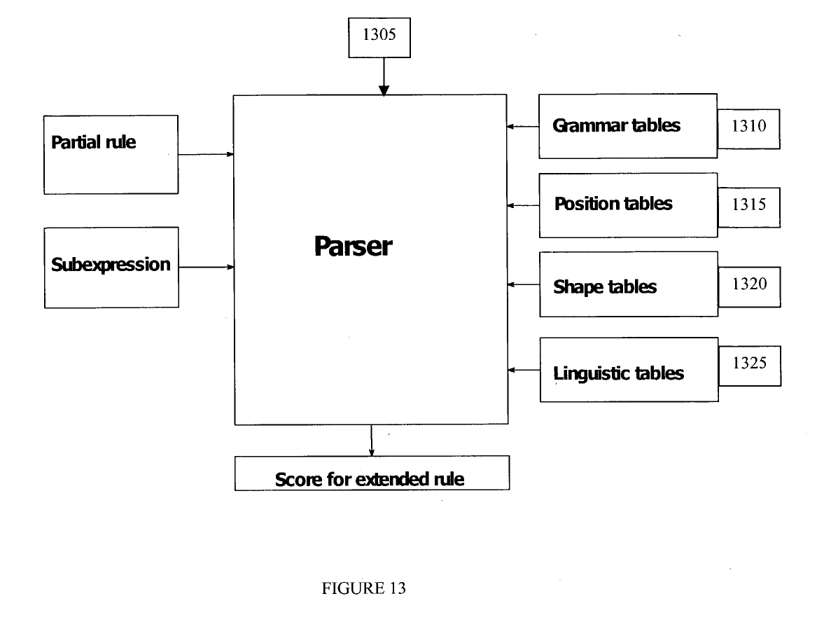

After the editor constructs its input data it uses pattern recognition techniques to find the mathematical expression most likely represented by that input data. There are a number of techniques suitable to this problem. The preferred embodiment uses a stochastic version of Earley's algorithm to implement a stochastic parser for a grammar describing a set of acceptable expressions. The rest of this section describes the methods used in the preferred embodiment. See FIG. 13. Other embodiments may change this approach in minor ways, such as using the Cocke-Younger-Kasami (CYK) algorithm in place of Earley's algorithm, or may use very different parsers or recognizers.

To edit expressions with incremental parsing, or carefully modifying existing parse trees, is initially tempting but proves to be unworkable. Seemingly simple edits can force significant changes in the syntactic structure of the expression, so the available information must be parsed from scratch to find a new parse tree. For example, suppose in the expression “α−β” a user selects “−β” and drags it out to form a new expression in an empty place. This is the very simplest of editing operations. In the target expression the characters and their positional relationships are known, and yet the parse tree of the result is completely different than the parse tree of the source.

In determining a parse for the input data there will generally be many possible parses. Uncertainties about the true identities of the input characters, uncertainties about the true positional relations as well as any ambiguities in the underlying grammar all multiply the number of possible parses of the input. The system determines the best parse. In this embodiment the editor first serializes the input data to produce an input stream, using heuristic relationships between the position and the input sequence—left or above is generally before, for example. In some cases the editor may try several different serializations to see which works best. The parser then accepts the items in this input stream in order, and uses tables of information including a shape model for recognizing characters, a position model encompassing the positional classes outlined above, a grammar describing the set of valid expressions, and optionally a linguistic model as described in Applicant's co-pending U.S. Provisional Application No. 60/357,510, entitled “Linguistic Support for a Recognizer for Handwritten Mathematics,” filed on Feb. 15, 2002, which is further incorporated in its entirety herein by reference (hereinafter referred to as “Applicant's co-pending application”).

The job of the parser is to match the input against grammar rules representing the structure of the valid expressions. The right hand side of each rule contains terminal symbols, representing the characters actually present in an expression, and nonterminal symbols representing more complex subexpressions. The key piece of information needed to parse the input is a score or probability for how well a rule in the grammar matches a particular range of input data. The score is made up of several components: 1) a score for each symbol on the right hand side of the rule; 2) a rule score; 3) a positional score; and 4) a linguistic score.

For a nonterminal symbol the symbol score just comes from an earlier part of the parse. A terminal symbol can be matched against a known symbol or against a set of handwritten strokes. In the symbol case the score is either perfect or impossible, depending on whether the symbol in the rule matches the symbol in the input data or not. In the ink case the score is returned by an underlying character recognizer.

The rule score represents semantic information about the input. It is a rule score, for example, which makes the interpretation of “sin” as the product of three variables less likely than the interpretation as a trig function.

The linguistic score is described in Applicant's co-pending application, and represents a measure of likelihood of the proposed interpretation in the body of all the expressions covered by the linguistic model.

The positional score represents how well the expression elements match the positional patterns required by the rule. In the preferred embodiment of the present invention, the system utilizes quantitative statistical models to score position relations in the ink-to-ink and text-to-ink classes. For example, consider a rule defining a definite integral:

integral: intsign lower upper body

In the grammar used by the preferred embodiment there are positional relations between the integral sign and the lower limit; between the integral sign and the upper limit; and between the integral sign and the body. The positional score for the rule is the sum of the positional scores for these three relations. Consider the relation between the integral sign and the upper limit. The positional scoring depends on the class of the relation between these two. In the ink-to-ink class, the editor uses a quantitative statistical model which returns a score indicating how well the relative positions match the patterns seen in this situation in training data. The ink-to-text class uses the same type of quantitative statistical model, but in this case the model used was trained on data which combined ink and text, so the parameters may be different. If the symbolic class applies, then the positional score is either perfect or impossible—perfect if there is an EXPONENT relation between the integral and part of the upper limit, and no conflicting relations apply; and impossible otherwise. In the location class case, the result is perfect if the material in the upper limit subexpression is mapped to the exponent location on the integral. In mixed cases, the position module looks at the leftmost part of the upper limit subexpression to decide how to score the positional relation.

This completes the description of how this embodiment of the editor uses its mixed input data set to generate a score for how well a grammar rule matches a section of input data. In this embodiment the editor uses Earley's algorithm to combine the results for different rules to find an optimal parse tree for the whole expression.

### AN EXAMPLE

Consider a typical editing scenario. Suppose the user adds more ink to an existing expression, as in FIG. 5. Consider the character information available in this parse. Some of the characters—the ones in the existing text—are known, and some are just present as ink and are not known. In terms of the character scores for the parse, if matching a text character there is no uncertainty, and the score is either perfect or impossible. If matching ink against a character, the character score is generated by a character recognizer.

Thus in this example the input sequence to the parser is not a sequence of strokes, but rather the following sequence having a mixture of text and ink:

stroke stroke p+stroke stroke q

Where a parser for a textual language would take a character sequence as input, and a handwriting recognizer takes a stroke sequence as input, for the editor the input is a mixture of the two.

### Conclusion

The editor uses a two step process to identify the edited expression. It first constructs a general input data set containing known and unknown characters, and known and unknown positional relations. It then uses pattern recognition technology—a stochastic parser in the preferred embodiment—to identify the most likely result. Some embodiments may overlap the creation of the input data set with its recognition.

### Dealing With Ambiguity

The present invention handles syntactic ambiguity—that is, ambiguity that remains even if given the characters and positional relations exactly. A grammar is unambiguous if, roughly, each input has no more than one valid parse. For example, English is ambiguous because the phrase “fruit flies” can be parsed two different ways, with “flies” as either a noun or a verb.

Any grammar which aims to capture a significant part of ordinary mathematics will necessarily be ambiguous. For example, the expression sinθ is ambiguous if the grammar allows implicit multiplication. The expressions sin 2θ and sin θ sin τ are ambiguous. A human reader would interpret these as sin(2θ) and (sin θ)(sin τ) rather than (sin 2)θ and sin(θ sin τ). Note that in some cases—for example, in a display application—some of this ambiguity may be irrelevant to the user. In other applications, such as a calculator, the interpretation needs to be exact.

The present system uses three methods to handle ambiguous expressions. First, it uses parsing technology designed to choose a “natural” interpretation of the input as frequently as possible. Second, the user interface makes it easy to see or to discover how the system interprets an ambiguous expression. Third, the editing facilities make it easy to switch between alternate interpretations.

The editor in the preferred embodiment uses an attributed stochastic grammar which, for example, gives “sin” a better score as a trigonometry function than a product, and uses properties like numeric and nesting level to guide the results. As an example, the interpretation of sin θ sin τ as sin(θ sin τ) is discouraged because the attribute system penalizes large product expressions in certain places, such as function arguments without brackets. The techniques described in the co-pending patent application also improve the score of frequently used constructions, which makes it more likely that the intended interpretation is chosen by the system.

### Showing the System 's Interpretation

To the extent possible, the present invention displays its results using distinguishable typeface conventions which help the user determine what the results is. For example, “sin x” and “sinx” would be presented with different typefaces to distinguish the function from the multiplication.

The editor includes a command to fully bracket an expression, so if the user is uncertain about the system's interpretation brackets can be inserted to remove the uncertainty. The inserted brackets do not change the meaning of the expression, but show exactly how it is associated. For example, “ax²+bx+c” would become ((ax²)+(bx))+c. If the system's interpretation specified by the brackets agrees with the user's intention the user can keep the brackets, or remove them with the undo command. If the user intended something different, the user can remove the brackets with the undo command and then edit the expression to bring it into compliance, for example by writing in brackets in the desired locations.

### Choosing a Different Interpretation

The system allows the user to force any legal interpretation of the input including, for example the following. 1) The user might want to change the structure of the parse tree by adding brackets. The user is free to add brackets by writing them in any legal location. 2) The user might want to change the role of part of the expression. An example would be changing functions to variables, or vice versa. This applies to known functions, like “sin,” as well as to individual variables which might have roles as functions in some semantic contexts. The handwritten forms of the letter “x” and the symbol for times are often identical, so although the text makes clear which the system is using, changing between them is the same kind of change of role task as for functions and variables. For these cases the user asks for an alternate recognition of the part to be changed. The alternate recognition material delivers different meanings of the material, as well as different characters or positions.

### Handling Ungrammatical Fragments

Even if a user starts with an expression valid in the system's grammar, it is easy to attempt to create invalid expressions. In FIG. 4, for example, the result is not a valid expression in the grammar of the preferred embodiment.

In certain circumstances, rejection is the best choice. For example, given the expression “ab,” the user can promote the second factor to make it “a^{b}”. However, if the user tries to promote the b again, there is no obvious alternative to rejecting the effort with an error message.

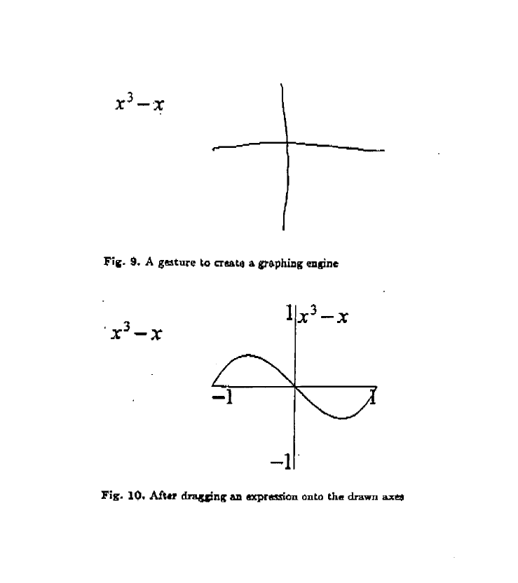

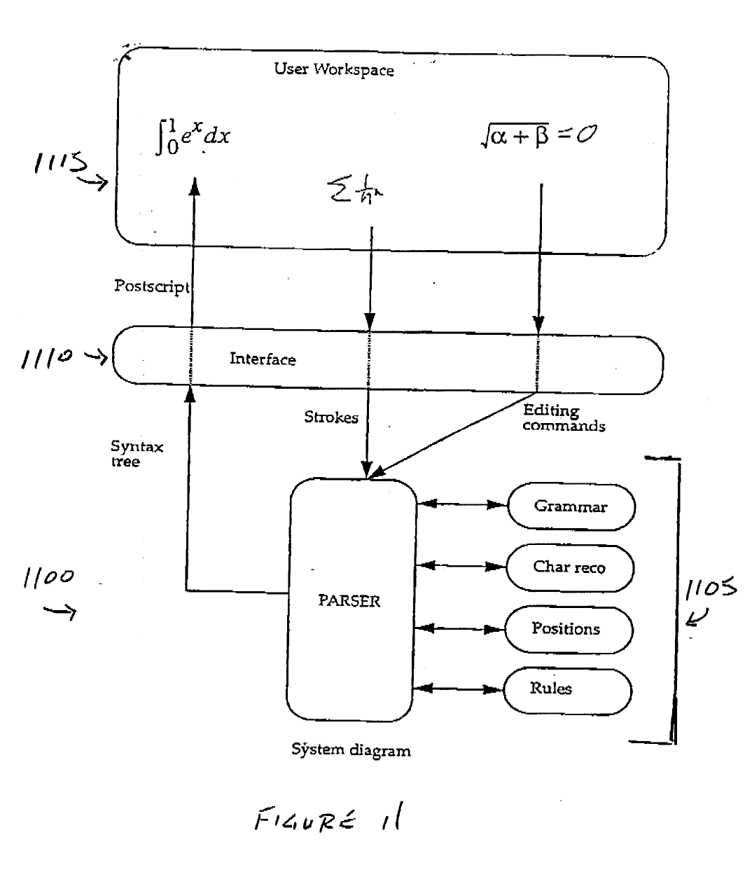

In other editing operations the system uses wildcard characters to provide additional flexibility to the user. In the deletion in FIG. 4, the system responds as in FIG. 8. This is useful for providing feedback to the user, and it supports sequences of editing commands which don't have to produce a strictly valid expression at every step. The user can proceed to overwrite the wildcard, or drag another expression onto it, or use other editing commands to restore the expression to a valid state.

The system interprets the invalid fragment using a minimum number of wildcards. For example, if in FIG. 8 the user crosses out the plus sign, the system produces a single a with no wild cards, since the remaining character is valid all by itself.

The editor implements the wildcard characters with the same basic method it uses for its other tasks. If it is unable to find a valid interpretation of the input data, it considers adding a special wildcard character to the input. The parser accepts a wildcard character as matching any subexpression with any positional relation. The editor makes several attempts to introduce one or a few wildcard characters at promising places in the input material determined by a list of heuristic rules. Thus this is another way in which the editor performs its tasks using generalized input data.

### Preserving Syntactic Structure

As noted above, any editing action can significantly affect the syntactic structure of an expression. Where this action is undesirable the present system optionally tries to preserve the overall syntax of the expressions during the editing process. For example, if the user copies the expression “c+d” onto the “a” in the expression “ab,” a direct textual substitution leads to “c+db.” However, the user may regard “(c+d)b” as the better choice, with brackets generated to maintain the previous syntactic structure. Thus, in certain instances, the editor will generate brackets around introduced material to force the introduced material to be parsed as a single subexpression.

### How to Preserve Syntactic Structure

As noted previously, an editing action leads to a modified input stream to the parser. The system may have a block of newly introduced material as a contiguous subsequence of the input stream. (If there are several separate blocks of introduced material, consider bracketing them separately.) The editor can then consider inserting brackets into the input stream around the introduced section, whether it is ink or text. The introduced brackets will have a LEFT-RIGHT positional relation with base elements of the introduced section; in relation to the outside material, they will inherit the positional relations of the introduced section. The editor will break any old positional relations between the introduced section and the outside material. This gives a second version of the input data, which may or may not be parsable. If the editor successfully parses it, the result is used as the one which preserves syntactic structure.

### When to Preserve Syntactic Structure

How the system determines when to introduce brackets or not is as follows: using the parse tree from completing the edit without brackets, the system finds the lowest node in the parse tree that contains all the new material. (A node in the parse tree is mixed if it contains both old material and material from the introduced section.) If the system located node has any mixed subnodes, then the system adds brackets to the expression.

Consider some examples. If the introduced material is parsed as one complete subnode of the parse tree, then no brackets are added and none are needed, since they would have no syntactic effect anyway. If the user adds to “a” to generate the expression “a+b” there are no mixed subnodes of the root node so brackets are not added. If, however in the expression “ab” the user replaces the variables “a” or “b” with the expression “c+d” then the system adds brackets.

The present system allows the user to switch between pure textual substitution and syntax preservation, and together with other editing facilities including, e.g., the undo/redo commands, if needed, the user can quickly correct any recognition or editing problem. For example, if the editor inserts brackets which the user does not want, it is easy to delete them.

### Exemplary User Interfaces

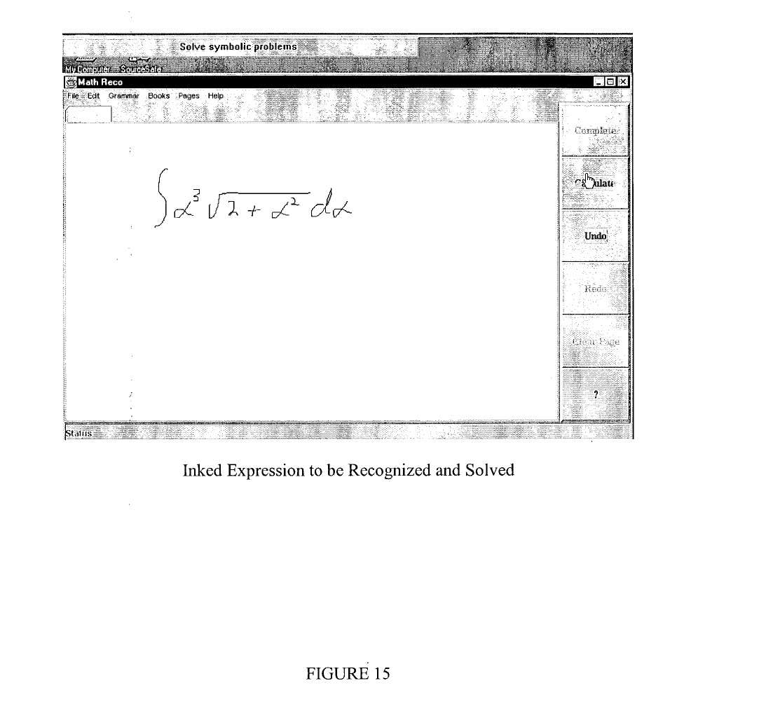

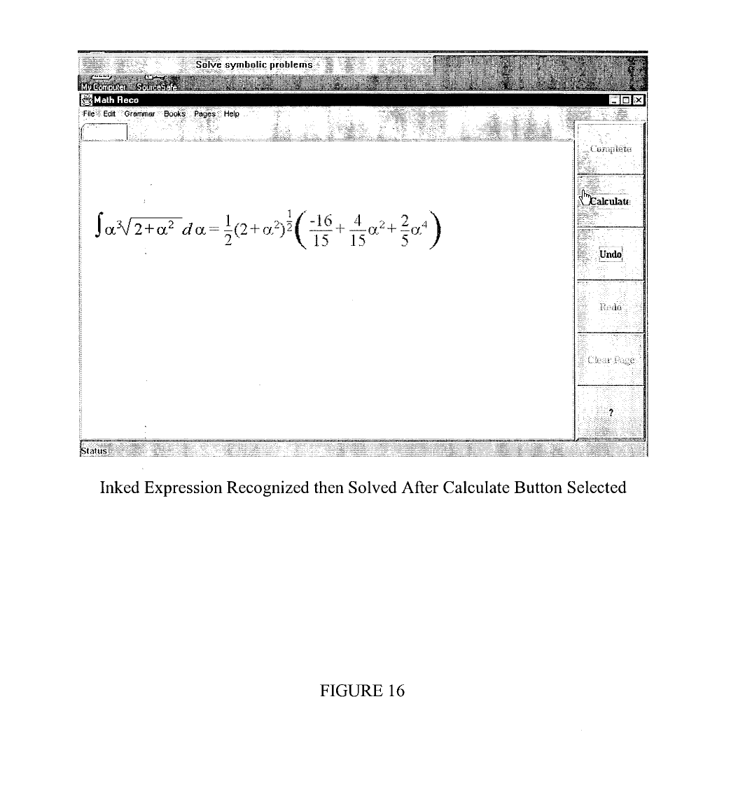

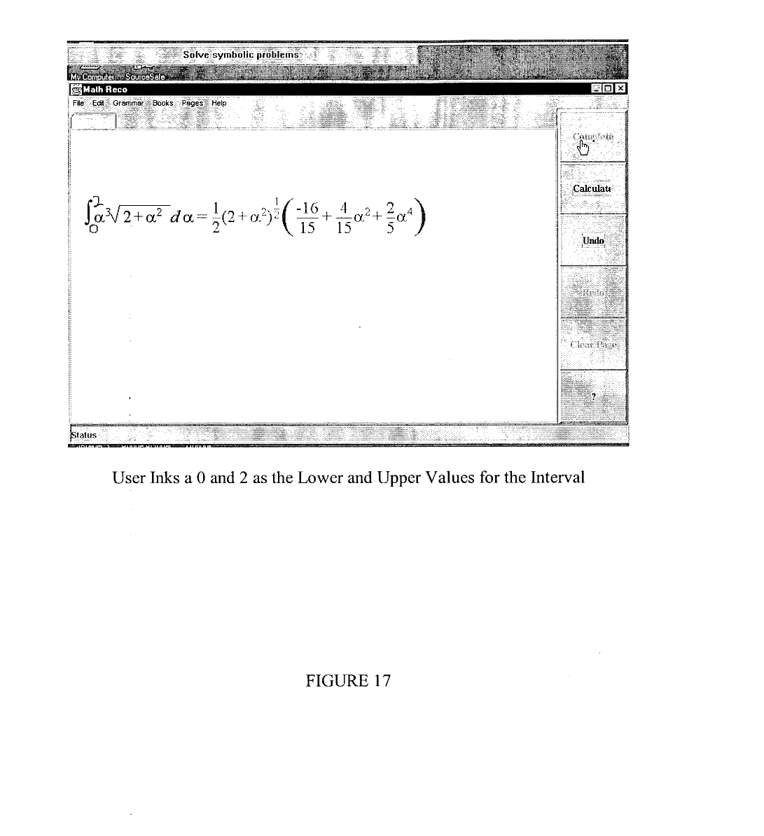

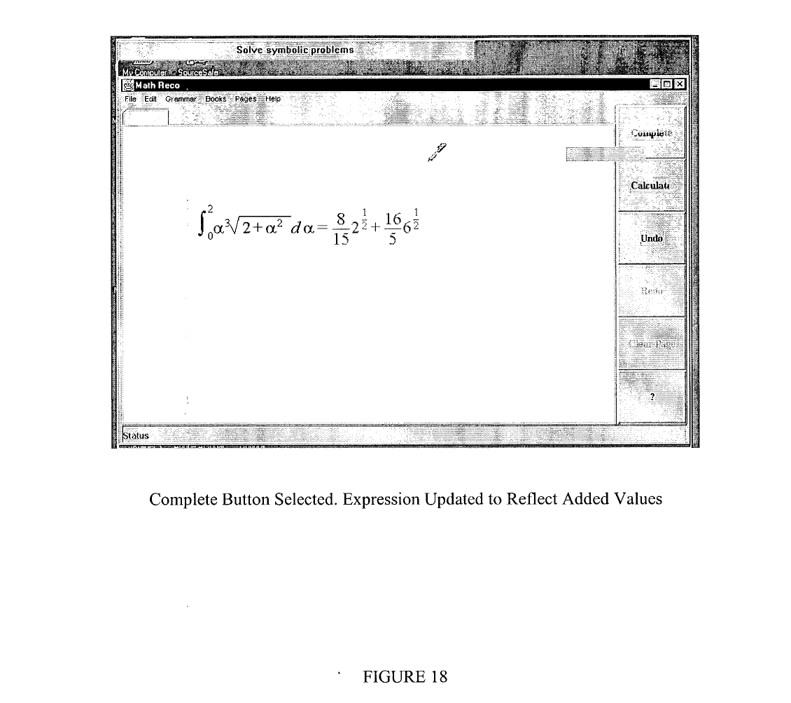

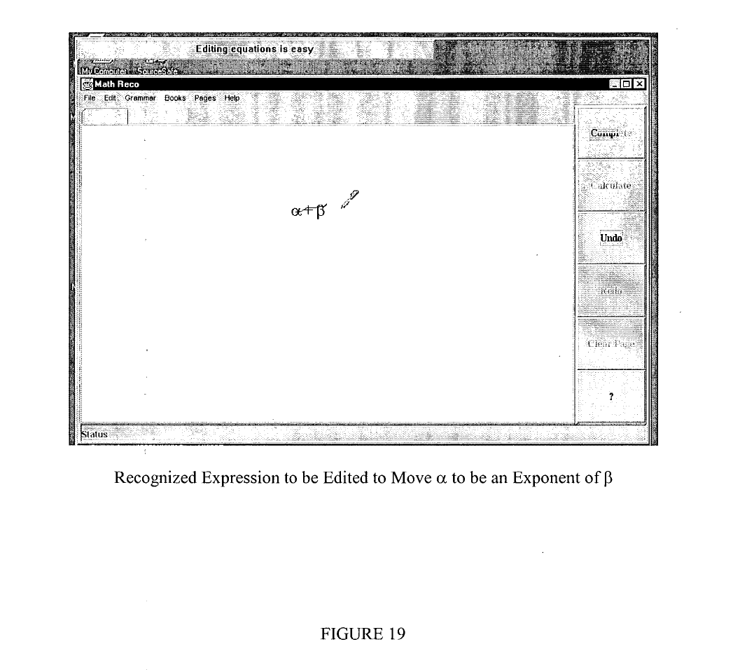

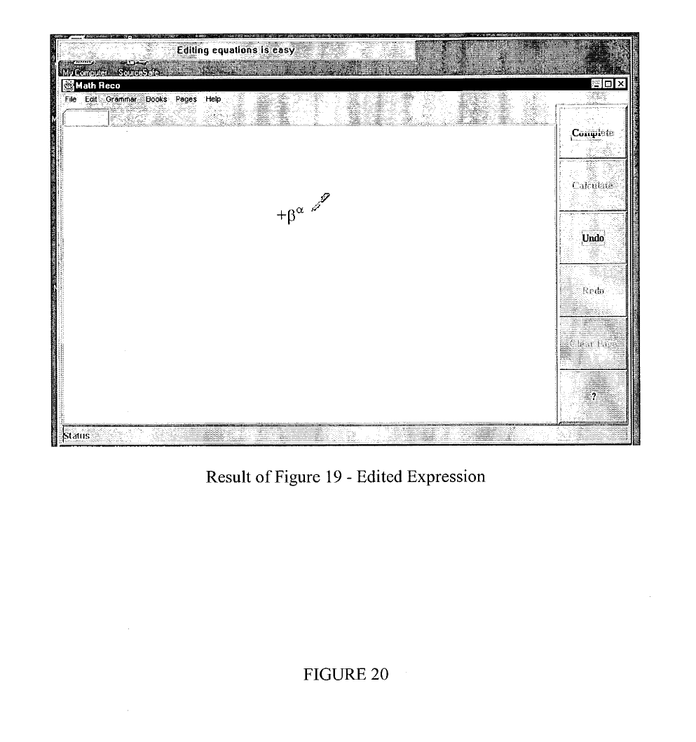

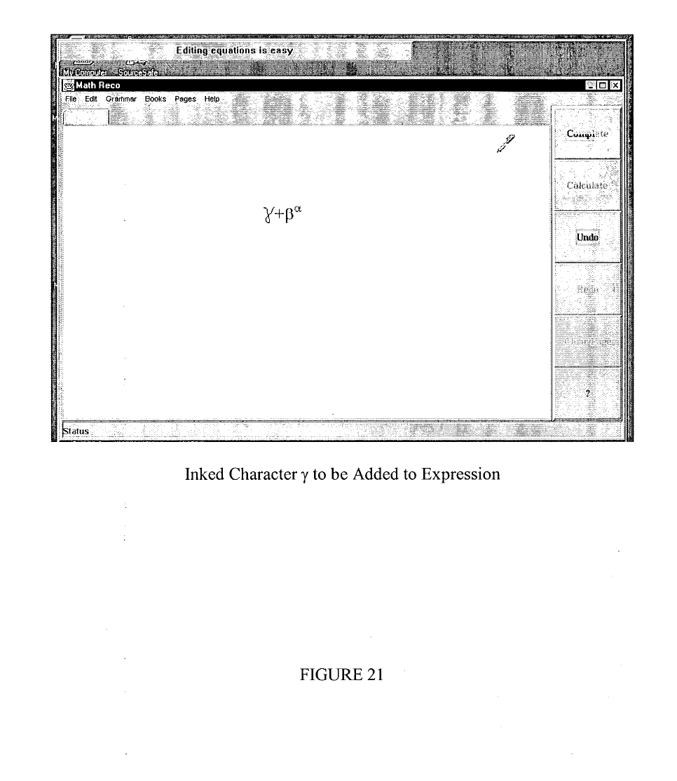

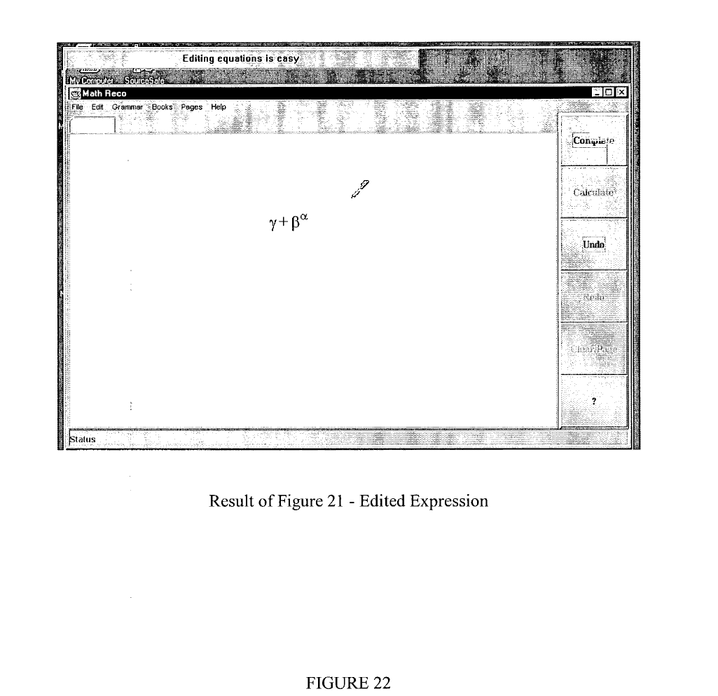

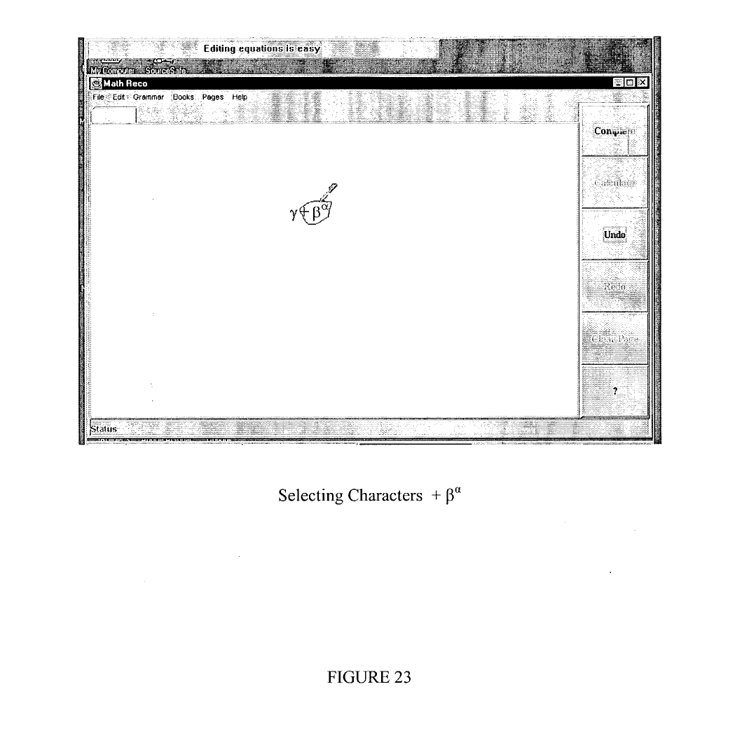

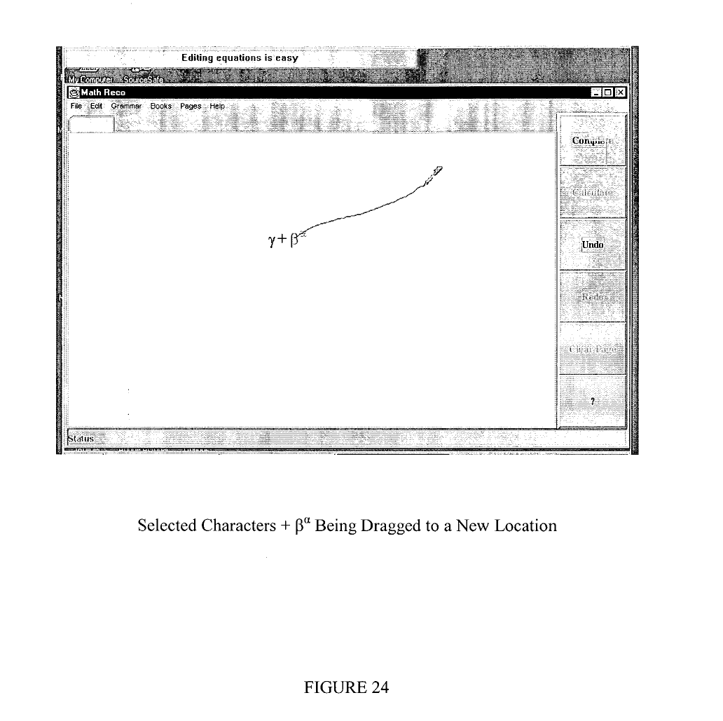

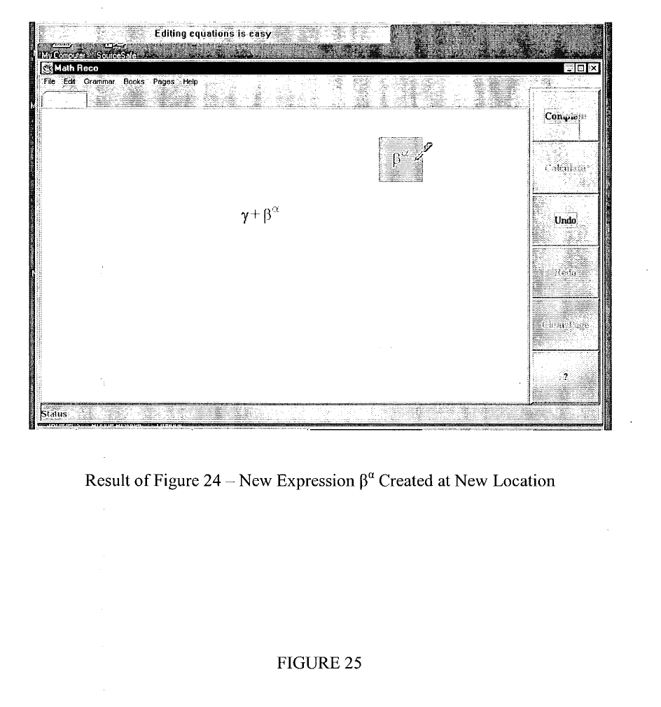

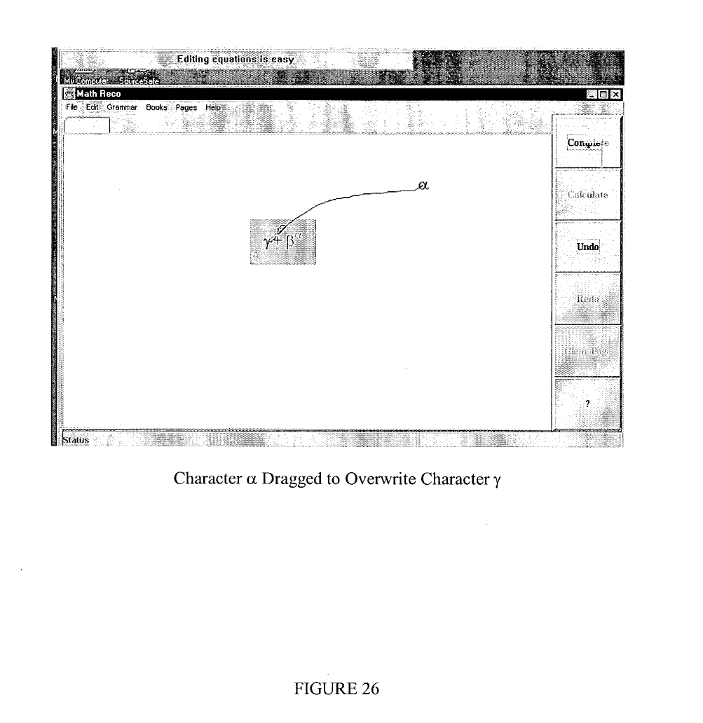

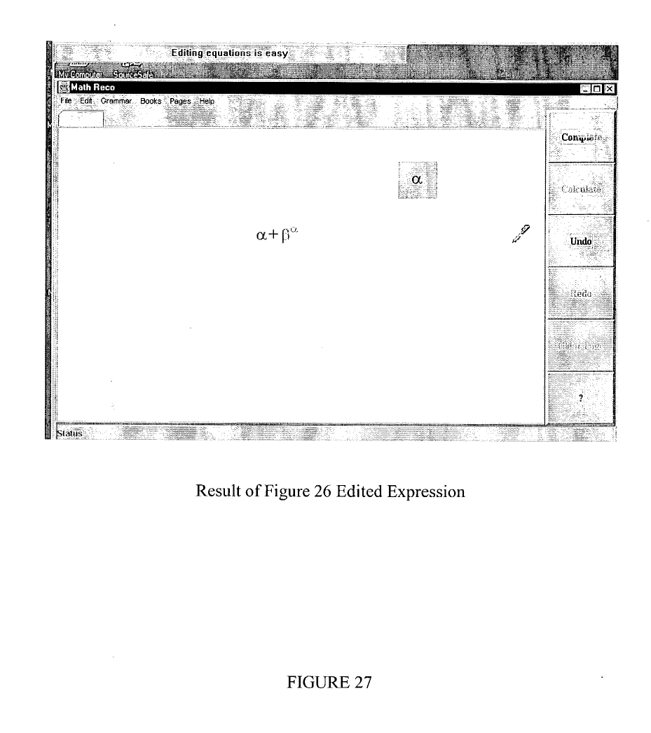

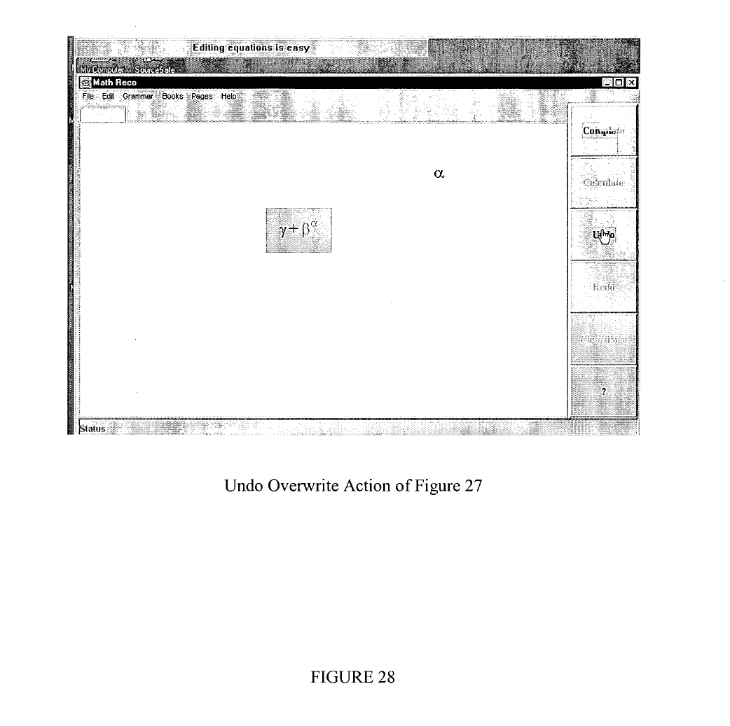

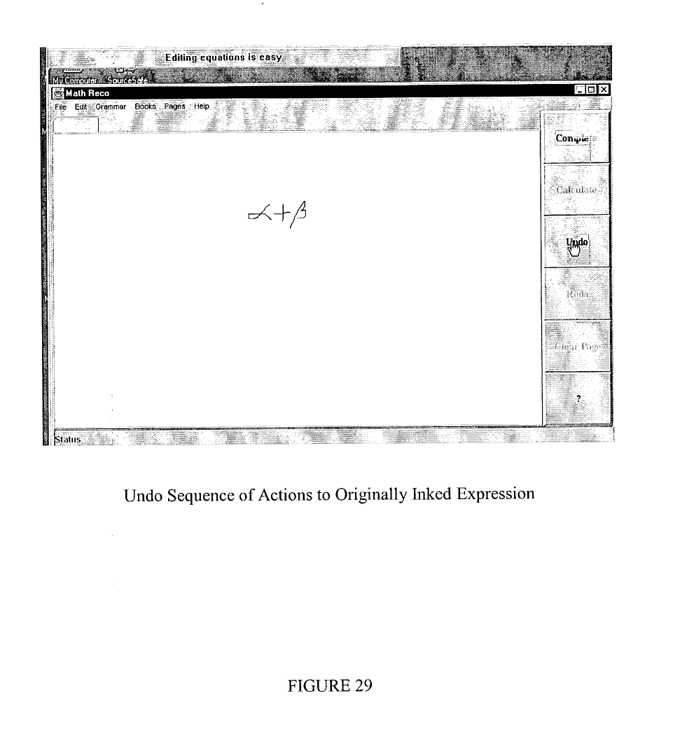

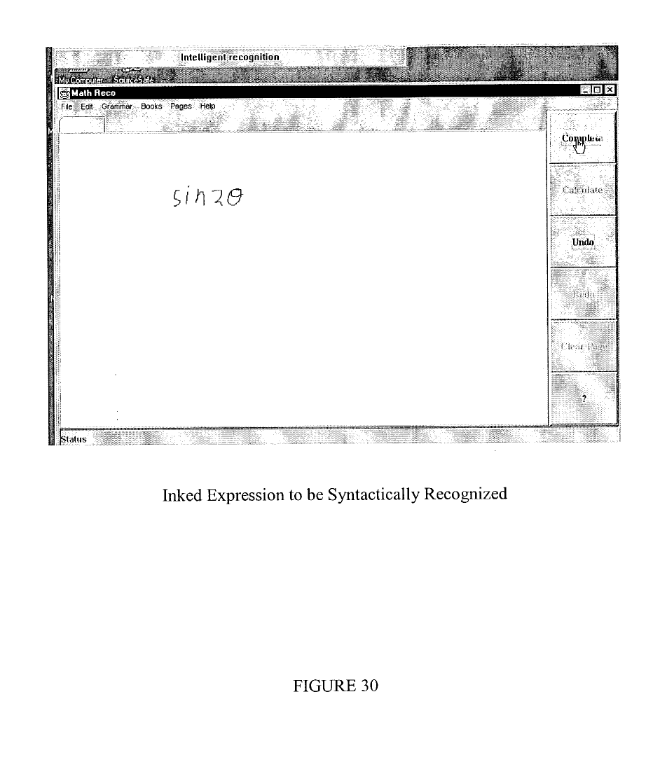

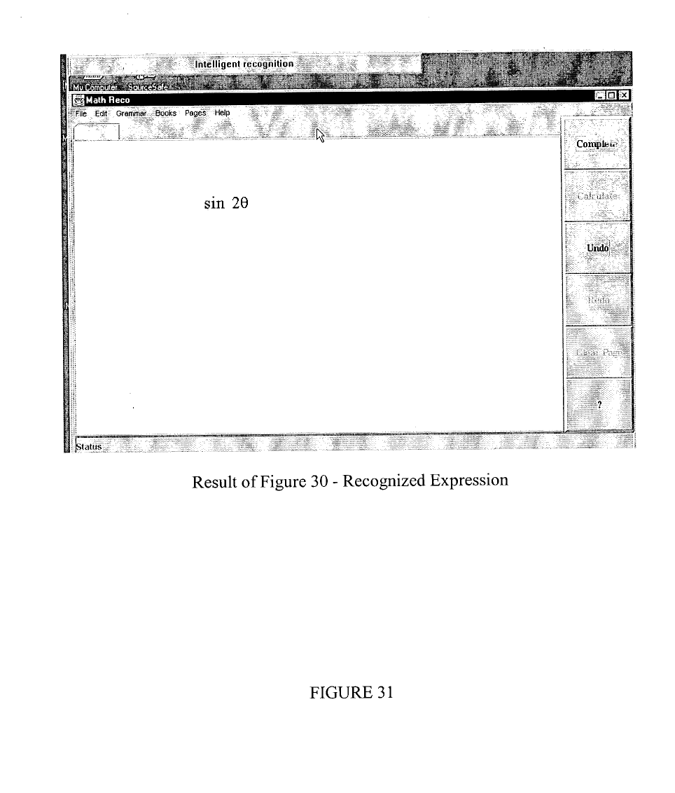

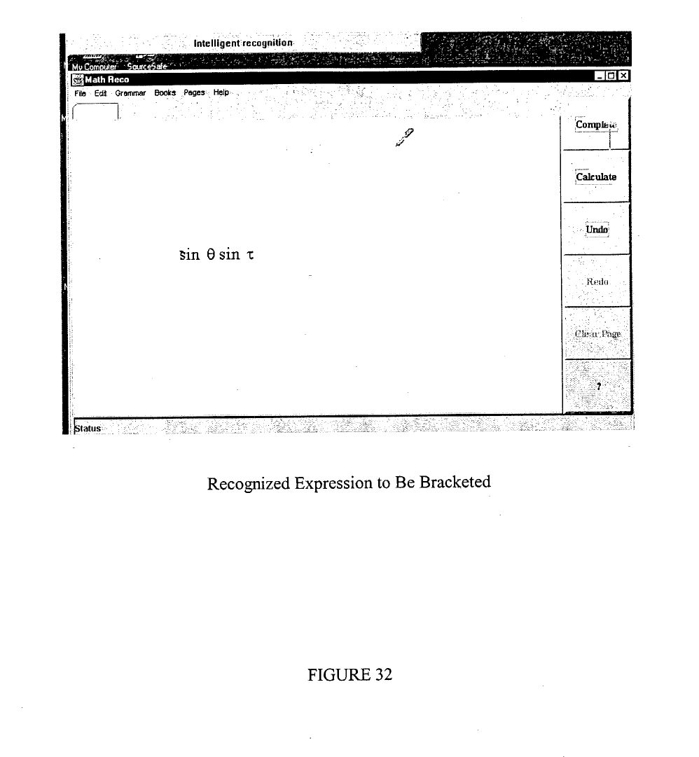

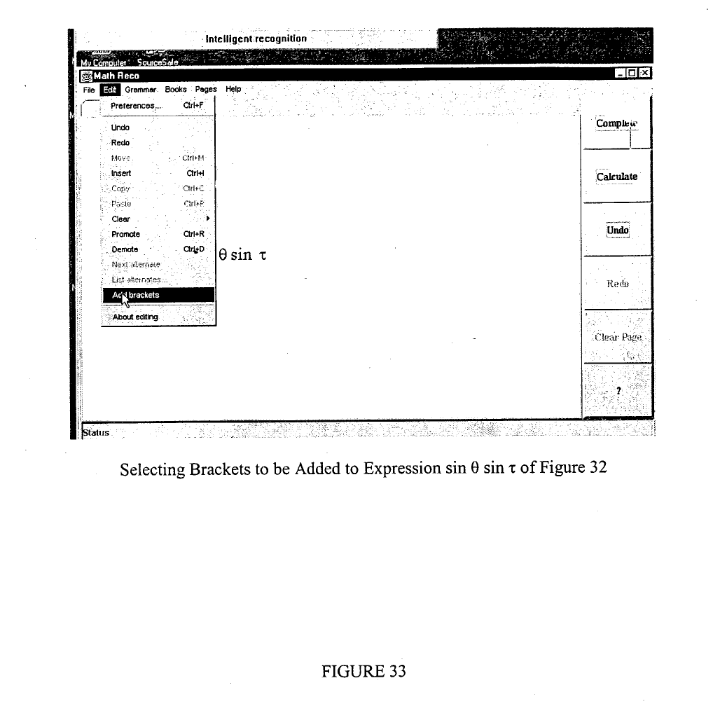

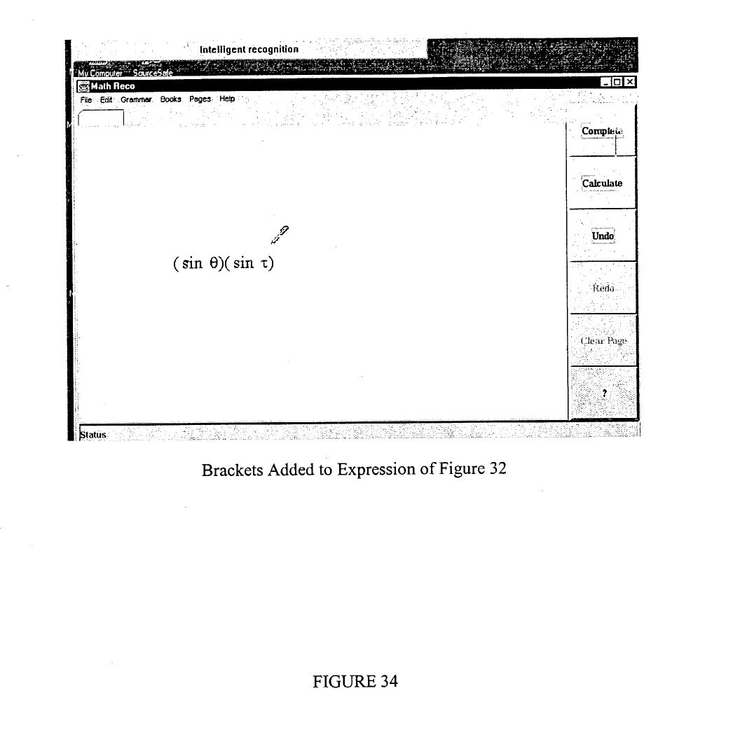

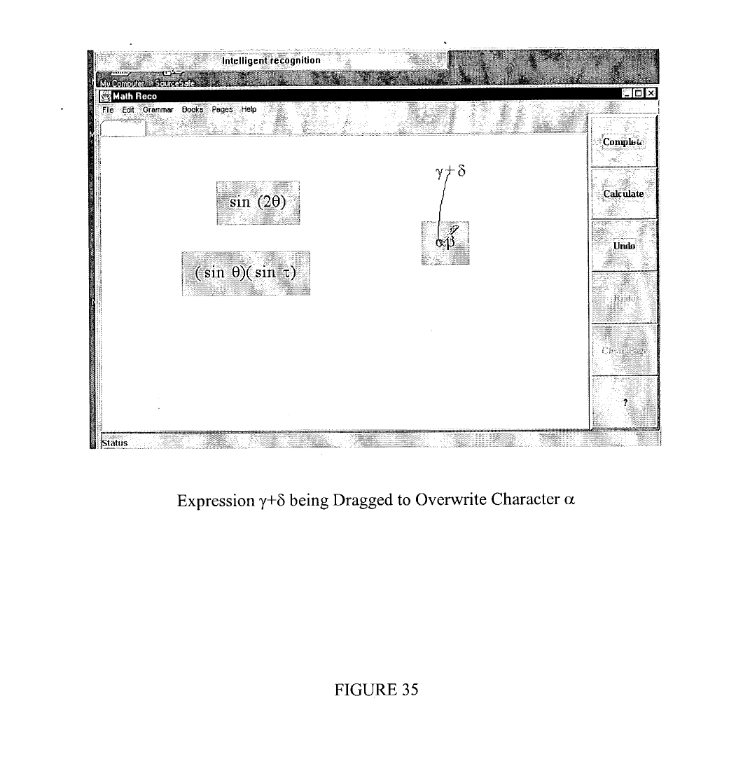

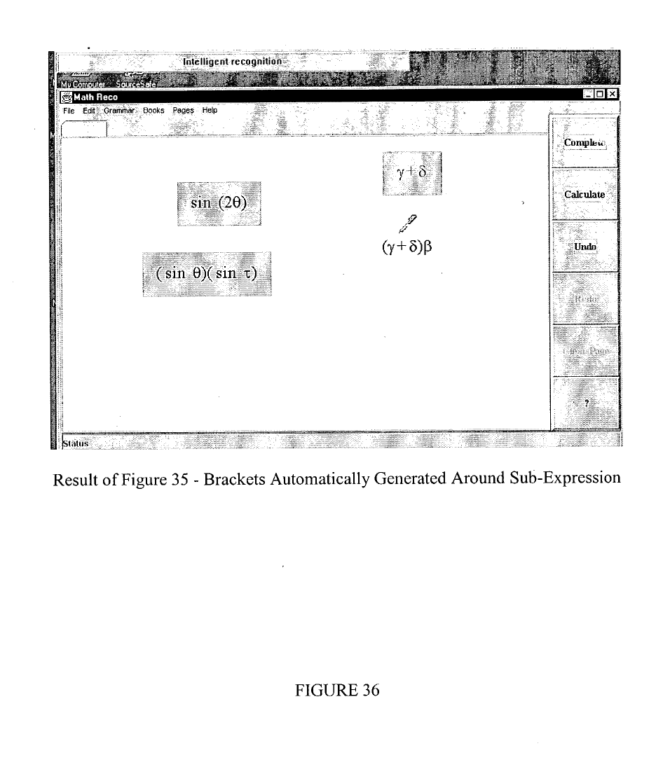

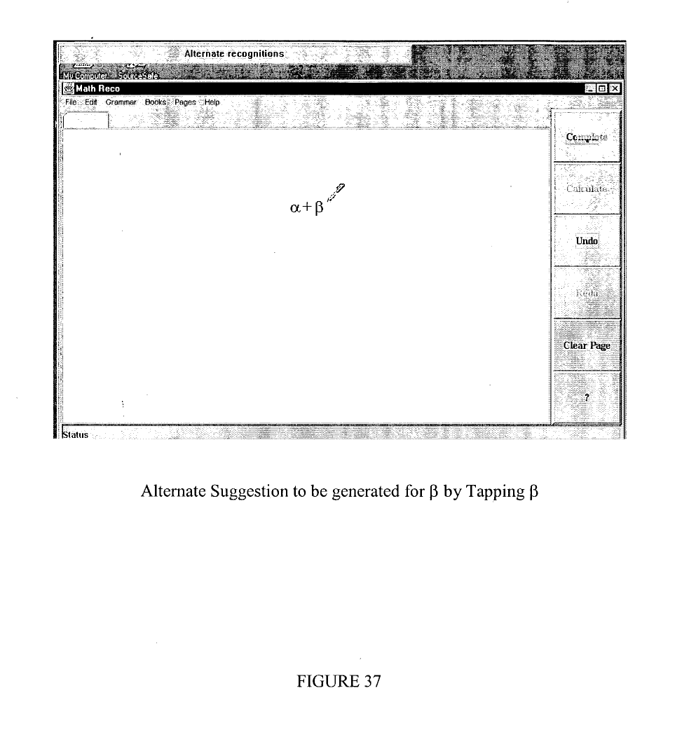

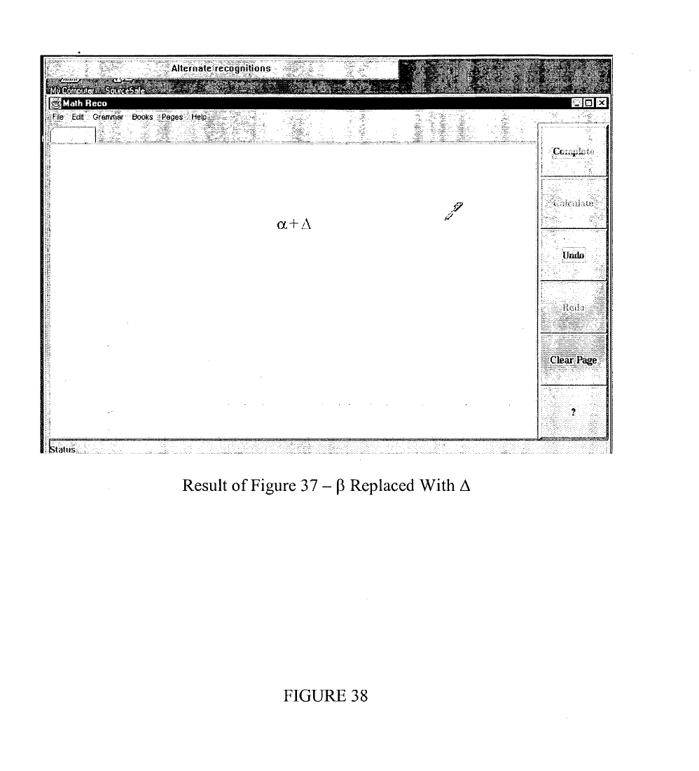

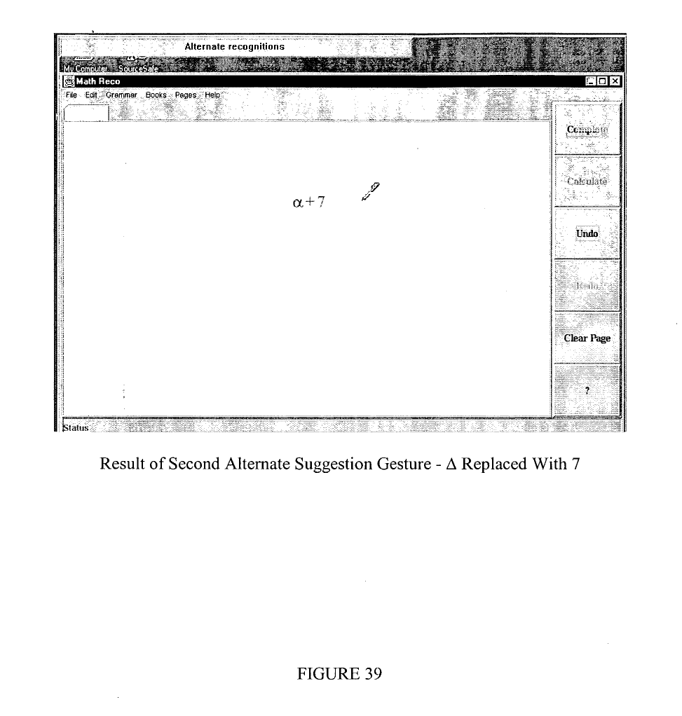

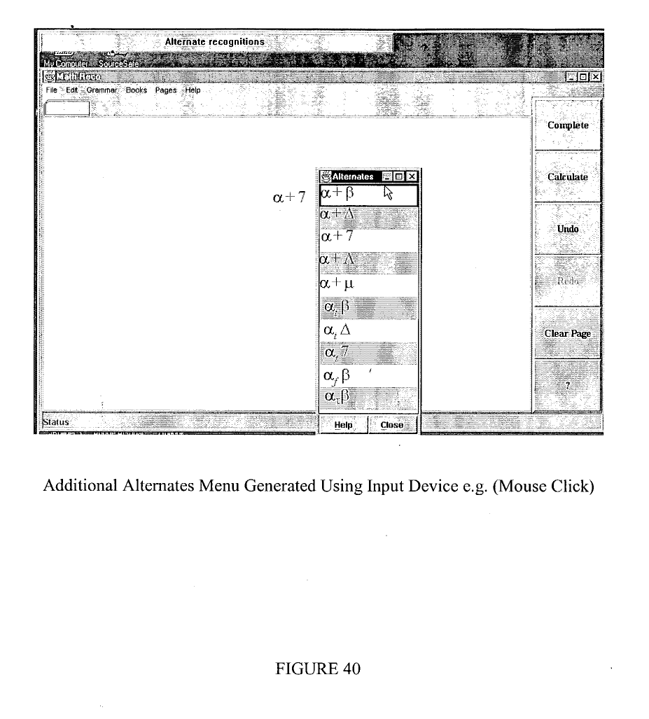

FIGS. 15-40 depict exemplary user interfaces embodying the present invention each illustrating the plurality of editing actions implemented by one embodiment of the present invention.

### Hardware

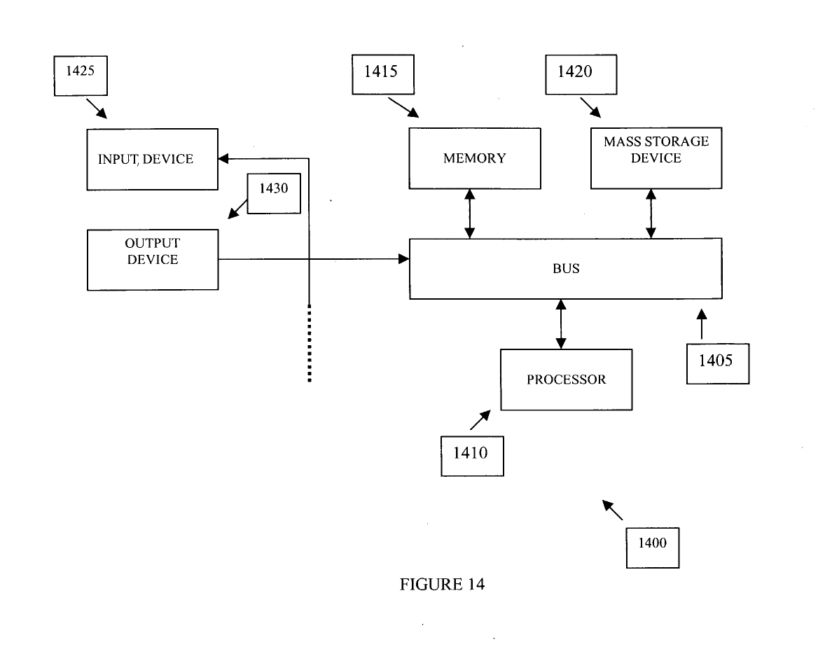

FIG. 14 illustrates an exemplary hardware configuration of a processor-controlled system on which the present invention is implemented. One skilled in the art will appreciate that the present invention is not limited by the depicted configuration as the present invention may be implemented on any past, present and future configuration, including for example, workstation/desktop/laptop/handheld configurations, client-server configurations, n-tier configurations, distributed configurations, networked configurations, etc., having the necessary components for carrying out the principles expressed herein.

In its most basic embodiment, the system 1400 comprises, but is not limited to, a bus 1405 that allows for communication among at least one processor 1410, at least one memory 1415 and at least one mass storage device 1420 for storing the various tables, i.e., at least the grammar, shape, position and linguistic tables. The linguistic tables are optional; in a minimal embodiment the shape tables are also optional. Optionally, the bus 1405 is also coupled to receive inputs from at least one input device 1425 and provide outputs to at least one output device 1430.

### Parser

FIG. 13 is a block diagram illustrating key components of an editor comprising a parser 1305. As shown, the editor includes a set of “tables,” which is used by the editor to perform its work. In its most basic embodiment the parsing functionality of the editor includes the parser 1305 and one or more tables, for example, position tables 1315 and optionally shape tables 1320. However, for improved accuracy, the particular embodiment of the editor shown in FIG. 13 includes four main table sets—grammar tables 1310, position tables 1315, shape tables 1320 and linguistic tables 1325.

A grammar, which supplies the grammar tables 1310, defines the types of expressions accepted and contains information about how expressions should be interpreted. Herein, an attributed stochastic grammar is preferably utilized.

A position model, which supplies the position tables 1315, provides a way to judge how well input data fits a particular positional pattern, like exponent or subscript.

A shape model, which supplies the shape tables 1320, provides a way to judge how much a sequence of input strokes looks like a particular character.

A linguistic model, which supplies the linguistic tables 1325, provides a way to judge how well a proposed interpretation of the input data matches commonly used patterns of symbols and expressions.

For additional details about the foregoing models and tables, the reader is encouraged to review Applicant's co-pending application.

### Conclusion

Having now described a preferred embodiment of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents of similar purpose, unless expressly stated otherwise. Therefore, numerous other embodiments of the modifications thereof are contemplated as falling within the scope of the present invention as defined by the appended claims and equivalents thereto.

Moreover, the techniques may be implemented in hardware or software, or a combination of the two. In one embodiment, the techniques are implemented in computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language. Each such computer program is preferably stored on a storage medium or device (e.g., CD-ROM, NVRAM, ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

What is claimed is:

1. A gesture driven modeless method of editing mathematical expressions, said method comprising the steps of:
providing at least one editing gesture comprising one or more strokes, said at least one editing gesture having associated therewith an editing action;
providing at least one unedited mathematical expression, said at least one unedited mathematical expression comprising one or more known characters and positional relations;
providing stroke input consisting of one or more strokes representing said at least one editing gesture;
in the presence of said at least one unedited mathematical expression, identifying said at least one editing gesture and its said associated information; and
executing said associated editing action of said editing gesture to edit said at least one unedited mathematical expression to generate at least one valid edited mathematical expression, said editing action governed by the current context of said at least one unedited mathematical expression thereby providing a modeless environment for a user.

2. A method as in claim 1 wherein said execution step further comprises the step of clarifying any syntactic ambiguity of said at least one valid edited mathematical expression.

3. A method as in claim 1 wherein said gesture identification step uses information about start and end point locations of said stroke input, said one or more unedited characters underneath or adjacent said stroke input and/or shape information about said stroke input in distinguishing said gesture.

4. A method as in claim 1 wherein said execution step further comprises the step of maintaining the appropriate syntax of said at least one valid edited mathematical expression.

5. A method as in claim 1 wherein said execution step further comprises the step of processing any ungrammatical fragment resulting from said editing action to generate said least one valid edited mathematical expression.

6. A method as in claim 1 wherein said gesture identification step further comprises the step of performing one or more logical tests on said stroke input to determine if said stroke input is one of said editing gestures.

7. A method as in claim 1 wherein said at least one editing gesture is chosen from the group consisting of SELECT, MOVE, DELETE, COPY, INSERT, ALTERNATE SUGGESTION and OVERWRITE gestures.

8. A method as in claim 7 wherein said at least one editing gesture is an ALTERNATE SUGGESTION gesture having an associated ALTERNATE SUGGESTION editing action, said method further comprising the steps of:
providing stroke input consisting of one or more strokes representing said ALTERNATE SUGGESTION gesture;
in the presence of said at least one unedited mathematical expression, identifying said ALTERNATE SUGGESTION gesture; and
executing said ALTERNATE SUGGESTION editing action to replace said one or more characters of said unedited expression with one or more new characters to generate said at least one valid edited mathematical expression representing an alternate expression.

9. A method as in claim 7 wherein said at least one editing gesture is an INSERT gesture having an associated INSERT editing action, said method further comprising the steps of:
providing stroke input consisting of one or more strokes representing new characters to be added to said unedited mathematical expression;
providing stroke input consisting of one or more strokes representing said INSERT gesture;
identifying said at least one new characters;
in the presence of said at least one unedited mathematical expression, identifying said INSERT gesture; and
executing said INSERT editing action to add said new characters to said at least one unedited mathematical expression to generate said at least one valid edited mathematical expression.

10. A method as in claim 7 wherein said at least one editing gesture is a SELECT gesture having an associated SELECT editing action, said method further comprising the steps of:
providing stroke input consisting of one or more strokes representing said SELECT gesture;
in the presence of said at least one unedited mathematical expression, identifying said SELECT gesture; and
executing said associated SELECT editing action to tag a syntactically contiguous portion of said at least one unedited mathematical expression for use in generating said at least one valid edited mathematical expression.

11. A method as in claim 7 wherein said at least one editing gesture is a MOVE gesture having an associated MOVE editing action, said at least one unedited mathematical expression at a first location, said method further comprising the steps of:
providing stroke input consisting of one or more strokes representing said MOVE gesture;
in the presence of said at least one unedited mathematical expression, identifying said MOVE gesture;
executing said associated MOVE editing action to position one or more characters of said at least one unedited mathematical expression at a second location different from said first location to generate said at least one valid edited mathematical expression and to delete said positioned one or more characters from said first location.

12. A method as in claim 7 wherein said at least one editing gesture is a COPY gesture having an associated COPY editing action, said at least one unedited mathematical expression at a first location, said method further comprising the steps of:
providing stroke input consisting of one or more strokes representing said COPY gesture;
in the presence of said at least one unedited mathematical expression, identifying said COPY gesture;
executing said associated COPY editing action to position one or more characters of said at least one unedited mathematical expression at a second location different from said first location to generate said at least one valid edited mathematical expression.

13. A method as in claim 7 wherein said at least one editing gesture is a DELETE gesture having an associated DELETE editing action, said method further comprising the steps of:
providing stroke input consisting of one or more strokes representing said DELETE gesture;
in the presence of said at least one unedited mathematical expression, identifying said DELETE gesture;
executing said associated DELETE editing action to remove one or more characters from said at least one unedited mathematical expression to generate said at least one valid edited mathematical expression.

14. A method as in claim 7 wherein said at least one editing gesture is an OVERWRITE gesture having an associated OVERWRITE editing action, said method further comprising the steps of:
providing stroke input consisting of one or more strokes representing one or more unknown characters and positional relations;
providing stroke input consisting of one or more strokes representing said OVERWRITE gesture;
identifying said one or more unknown characters and positional relations;
in the presence of said at least one unedited mathematical expression, identifying said OVERWRITE gesture; and
executing said associated OVERWRITE editing action to replace said one or more known characters of said at least one unedited mathematical expression with said identified one or more unknown characters and positional relations to generate said at least one valid edited mathematical expression.

15. A method as in claim 7 wherein said at least one editing gesture is an OVERWRITE gesture having an associated OVERWRITE editing action, said method further comprising the steps of:
providing a second set of one or more known characters and positional relations;
providing stroke input consisting of one or more strokes representing said OVERWRITE gesture;
in the presence of said at least one unedited mathematical expression, identifying said OVERWRITE gesture; and
executing said associated OVERWRITE editing action to replace said one or more known characters and positional relations of said at least one unedited mathematical expression with said second set to generate said at least one valid edited mathematical expression.

16. A method as in claim 9 wherein, said new characters of said stroke input have unknown positional relations associated therewith, said execution step further comprises the steps of:
constructing a data set comprising said one or more known and new characters and said known and unknown positional relations; and
recognizing said data set to identify a mathematical expression most likely represented by said data set to generate said at least one valid edited mathematical expression.

17. A method as in claim 14 wherein, said new characters of said stroke input have unknown positional relations associated therewith, said execution step further comprises the steps of:
constructing a data set comprising said one or more known and new characters and said known and unknown positional relations; and
recognizing said data set to identify a mathematical expression most likely represented by said data set to generate said at least one valid edited mathematical expression.

18. A method as in claim 15 wherein, said new characters of said stroke input have unknown positional relations associated therewith, said execution step further comprises the steps of:
constructing a data set comprising said one or more known and new characters and said known and unknown positional relations; and
recognizing said data set to identify a mathematical expression most likely represented by said data set to generate said at least one valid edited mathematical expression.

19. A method as in claim 11 wherein said execution step further comprises the steps of:
constructing a data set comprising said one or more known characters and positional relations; and
recognizing said data set to identify a mathematical expression most likely represented by said data set to generate said at least one valid edited mathematical expression.

20. A method as in claim 12 wherein said execution step further comprises the steps of:
constructing a data set comprising said one or more known characters and positional relations; and
recognizing said data set to identify a mathematical expression most likely represented by said data set to generate said at least one valid edited mathematical expression.

21. A method as in claim 13 wherein said execution step further comprises the steps of:
constructing a data set comprising said one or more known characters and positional relations; and
recognizing said data set to identify a mathematical expression most likely represented by said data set to generate said at least one valid edited mathematical expression.

22. A method as in claim 1 further comprising the step of displaying said at least one valid edited mathematical expression in place of said at least one unedited mathematical expression.

23. A method as in claim 1 wherein said execution step uses a recognition method to favor a particular interpretation of said at least one valid edited mathematical expression.

24. A method as in claim 23 wherein said recognition method utilizes an attributed stochastic grammar to favor a particular interpretation of said at least one valid edited mathematical expression.

25. A method as in claim 23 wherein said recognition method utilizes linguistic information to favor a particular interpretation of said at least one valid edited mathematical expression.

26. A method as in claim 5 wherein said execution step processes any resulting invalid ungrammatical fragment by rejecting said ungrammatical fragment.

27. A method as in claims 5 wherein said execution step processes any resulting invalid ungrammatical fragment by adding one or more wildcard characters to said ungrammatical fragment to facilitate construction of said at least one valid edited mathematical expression, said one or more wildcard character matching any arbitrary sub-expression and positional relations.

28. A system for gesture driven modeless editing mathematical expressions, said system comprising:
at least one processor configured to:
provide at least one editing gesture comprising one or more strokes, said at least one editing gesture having associated therewith an editing action;
provide at least one unedited mathematical expression, said at least one unedited mathematical expression comprising one or more known characters and positional relations;
provide stroke input consisting of one or more strokes representing said at least one editing gesture;
in the presence of said at least one unedited mathematical expression, identify said at least one editing gesture and its said associated information; and
execute said associated editing action of said editing gesture to edit said at least one unedited mathematical expression to generate at least one valid edited mathematical expression, said editing action governed by the current context of said at least one unedited mathematical expression thereby provide a modeless environment for a user.

29. A system as in claim 28 wherein said processor is further configured to clarify any syntactic ambiguity of said at least one valid edited mathematical expression.

30. A system as in claim 28 wherein said processor is further configured to use information about start and end point locations of said stroke input, said one or more unedited characters underneath or adjacent said stroke input and/or shape information about said stroke input to distinguish said gesture.

31. A system as in claim 28 wherein said processor is further configured to maintain the appropriate syntax of said at least one valid edited mathematical expression.

32. A system as in claim 28 wherein said processor is further configured to process any ungrammatical fragment resulting from said editing action to generate said least one valid edited mathematical expression.

33. A system as in claim 28 wherein said processor is further configured to perform one or more logical tests on said stroke input to determine if said stroke input is one of said editing gestures.

34. A system as in claim 28 wherein said processor is further configured to select at least one editing gesture from the group consisting of SELECT, MOVE, DELETE, COPY, INSERT, ALTERNATE SUGGESTION and OVERWRITE gestures.

35. A system as in claim 34 wherein said at least one editing gesture is an ALTERNATE SUGGESTION gesture having an associated ALTERNATE SUGGESTION editing action, said processor is further configured to:
provide stroke input consisting of one or more strokes representing said ALTERNATE SUGGESTION gesture;
in the presence of said at least one unedited mathematical expression, identify said ALTERNATE SUGGESTION gesture; and
execute said ALTERNATE SUGGESTION editing action to replace said one or more characters of said unedited expression with one or more new characters to generate said at least one valid edited mathematical expression representing an alternate expression.

36. A system as in claim 34 wherein said at least one editing gesture is an INSERT gesture having an associated INSERT editing action, said processor is further configured to:
provide stroke input consisting of one or more strokes representing new characters to be added to said unedited mathematical expression;
provide stroke input consisting of one or more strokes representing said INSERT gesture;
identify said at least one new characters;
in the presence of said at least one unedited mathematical expression, identify said INSERT gesture; and
execute said INSERT editing action to add said new characters to said at least one unedited mathematical expression to generate said at least one valid edited mathematical expression.

37. A system as in claim 34 wherein said at least one editing gesture is a SELECT gesture having an associated SELECT editing action, said processor is further configured to:
provide stroke input consisting of one or more strokes representing said SELECT gesture;
in the presence of said at least one unedited mathematical expression, identify said SELECT gesture; and
execute said associated SELECT editing action to tag a syntactically contiguous portion of said at least one unedited mathematical expression for use in generating said at least one valid edited mathematical expression.

38. A system as in claim 34 wherein said at least one editing gesture is a MOVE gesture having an associated MOVE editing action, said at least one unedited mathematical expression at a first location, said processor is further configured to:
provide stroke input consisting of one or more strokes representing said MOVE gesture;
in the presence of said at least one unedited mathematical expression, identify said MOVE gesture;
execute said associated MOVE editing action to position one or more characters of said at least one unedited mathematical expression at a second location different from said first location to generate said at least one valid edited mathematical expression and to delete said positioned one or more characters from said first location.

39. A system as in claim 34 wherein said at least one editing gesture is a COPY gesture having an associated COPY editing action, said at least one unedited mathematical expression at a first location, said processor is further configured to:
provide stroke input consisting of one or more strokes representing said COPY gesture;
in the presence of said at least one unedited mathematical expression, identify said COPY gesture;
execute said associated COPY editing action to position one or more characters of said at least one unedited mathematical expression at a second location different from said first location to generate said at least one valid edited mathematical expression.

40. A system as in claim 34 wherein said at least one editing gesture is a DELETE gesture having an associated DELETE editing action, said processor is further configured to:
provide stroke input consisting of one or more strokes representing said DELETE gesture;
in the presence of said at least one unedited mathematical expression, identify said DELETE gesture;
execute said associated DELETE editing action to remove one or more characters from said at least one unedited mathematical expression to generate said at least one valid edited mathematical expression.

41. A system as in claim 34 wherein said at least one editing gesture is an OVERWRITE gesture having an associated OVERWRITE editing action, said processor is further configured to:
provide stroke input consisting of one or more strokes representing one or more unknown characters and positional relations;
provide stroke input consisting of one or more strokes representing said OVERWRITE gesture;
identify said one or more unknown characters and positional relations;
in the presence of said at least one unedited mathematical expression, identify said OVERWRITE gesture; and
execute said associated OVERWRITE editing action to replace said one or more known characters of said at least one unedited mathematical expression with said identified one or more unknown characters and positional relations to generate said at least one valid edited mathematical expression.

42. A system as in claim 34 wherein said at least one editing gesture is an OVERWRITE gesture having an associated OVERWRITE editing action, said processor is further configured to:
provide a second set of one or more known characters and positional relations;
provide stroke input consisting of one or more strokes representing said OVERWRITE gesture; in the presence of said at least one unedited mathematical expression, identify said OVERWRITE gesture; and
execute said associated OVERWRITE editing action to replace said one or more known characters and positional relations of said at least one unedited mathematical expression with said second set to generate said at least one valid edited mathematical expression.

43. A system as in claim 36 wherein said new characters of said stroke input have unknown positional relations associated therewith, said processor is further configured to:
construct a data set comprising said one or more known and new characters and said known and unknown positional relations; and
recognize said data set to identify a mathematical expression most likely represented by said data set to generate said at least one valid edited mathematical expression.

44. A system as in claim 41 wherein said new characters of said stroke input have unknown positional relations associated therewith, said processor is further configured to:
construct a data set comprising said one or more known and new characters and said known and unknown positional relations; and
recognize said data set to identify a mathematical expression most likely represented by said data set to generate said at least one valid edited mathematical expression.

45. A system as in claim 42 wherein said new characters of said stroke input have unknown positional relations associated therewith, said processor is further configured to:
construct a data set comprising said one or more known and new characters and said known and unknown positional relations; and
recognize said data set to identify a mathematical expression most likely represented by said data set to generate said at least one valid edited mathematical expression.

46. A system as in claim 38 wherein said processor is further configured to:
construct a data set comprising said one or more known characters and positional relations; and
recognize said data set to identify a mathematical expression most likely represented by said data set to generate said at least one valid edited mathematical expression.

47. A system as in claim 39 wherein said processor is further configured to:
construct a data set comprising said one or more known characters and positional relations; and
recognize said data set to identify a mathematical expression most likely represented by said data set to generate said at least one valid edited mathematical expression.

48. A system as in claim 40 wherein said processor is further configured to:
construct a data set comprising said one or more known characters and positional relations; and
recognize said data set to identify a mathematical expression most likely represented by said data set to generate said at least one valid edited mathematical expression.

49. A system as in claim 28 wherein said processor is further configured to display said at least one valid edited mathematical expression in place of said at least one unedited mathematical expression.

50. A system as in claim 28 wherein said processor is further configured to use a recognition method that favors a particular interpretation of said at least one valid edited mathematical expression.

51. A system as in claim 50 wherein said recognition method utilizes an attributed stochastic grammar to favor a particular interpretation of said at least one valid edited mathematical expression.

52. A system as in claim 50 wherein said recognition method utilizes linguistic information to favor a particular interpretation of said at least one valid edited mathematical expression.

53. A system as in claim 32 wherein said processor is further configured to process any resulting invalid ungrammatical fragment by rejecting said ungrammatical fragment.

54. A system as in claims 32 wherein said processor is further configured to process any resulting invalid ungrammatical fragment by adding one or more wildcard characters to said ungrammatical fragment to facilitate construction of said at least one valid edited mathematical expression, said one or more wildcard character matching any arbitrary sub-expression and positional relations.
